(19) United States
(12) Patent Application Publication
(10) Pub. No.: US 2026/0222450 A1
(43) Pub. Date: Jul. 30, 2026

(54) CENTRALIZED SECURITY CONFIGURATION FOR DISTRIBUTED COMPUTING SYSTEMS

(71) Applicant: RAY RESEARCH, LTD., Ramat Gan (IL)

(72) Inventors: Ariel ZAMIR, Kibbutz Ramot Menashe (IL); Eric WOLF, Tel Aviv (IL); Dekel LEVKOVITCH, Savyon (IL)

(21) Appl. No.: 19/462,055

(22) Filed: Jan. 28, 2026

Related U.S. Application Data
(60) Provisional application No. 63/750,600, filed on Jan. 28, 2025.

(51) Int. Cl. H04L 9/40

(52) U.S. Cl. CPC H04L 63/20

(57) ABSTRACT

A computer-implemented method, comprising: operationally connecting to a distributed computer system comprising a plurality of system nodes; obtaining an inventory of all data objects in the distributed computer system; collecting metadata regarding each of the data objects; based on the metadata, applying a trained classification model to assign each of the data objects into one of a set of categories of data objects, based on a predicted likelihood that each data object will be accessed within a predefined time window; generating, based on the assigning, a graphical data object summary and security configurator which allows for centrally applying differential security controls profiles to each of the categories of data objects; and using the data object summary and security configurator to apply a specified the security controls profile to a respective one of the categories, wherein the security controls profile applies to all data objects assigned to the respective category.

### CROSS-REFERENCE TO RELATED APPLICATIONS

This application claims the benefit of priority from U.S. Provisional Patent Application No. 63/750,600, filed January 28, 2025, entitled “CENTRALIZED SECURITY CONFIGURATION FOR DISTRIBUTED COMPUTING SYSTEMS,” the contents of which are all incorporated by reference as if fully set forth herein in their entirety.

### FIELD OF THE INVENTION

This invention relates to the field of network and computer security, and specifically, mitigation of exposure to malicious software attacks.

### BACKGROUND

Intrusion by malicious software or malware that steals, erases, or modifies system resources, data, and private information is a growing problem. Malware cam come in the form of computer viruses, worms, trojan horses, spyware, keystroke loggers, adware, rootkits, and ransomware.

File-modifying malware include ransomware which aims to block access to system applications and files by encrypting data to make it inaccessible, typically until a ransom is paid. Another type of malware in this category is wipers, which erase (or wipe) data and files, making recovery difficult or impossible. A third type seeks to steal or exfiltrate data from a computer system. This class of malware is of particular concern for corporations, government agencies, and other enterprises that store confidential or irreplaceable data.

To counter these threats, enterprises and individuals use a range of security applications and services which scan computer systems for signatures of certain malware, in order to quarantine or disable the malware. However, these security applications are reactive in nature, and can fail to detect sophisticated security intrusions and take remedial actions before the malware is able to cause significant and often irreparable damage.

Many organizations use decentralized or distributed computing systems, wherein the computing system of the organization comprises multiple interconnected systems and storage locations. The multiple systems and storage nodes are often located at geographically different locations, over different private and public computing platforms. Thus, rather than centralizing data objects in one place, the data objects are located and stored on various platforms and devices, combining proprietary data centers (often located in various geographic locations) and public cloud and similar platforms. These locations and devices are in turn interconnected through one or more private or public networks, such as the Internet or a local area network (LAN).

Distributed computer systems offer advantages such as scalability, greater resilience and fault tolerance, reduced costs, improved performance, and ability to comply with various privacy and data management regulatory regimes.

However, distributed computer systems present security and data protection challenges, not least in the configuration and management of security controls across multiple locations and platforms. This problem is exacerbated due to the dynamic behavior of distributed systems, which are characterized by nodes frequently leaving and joining the system.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a computer-implemented method, comprising: operationally connecting to a distributed computer system comprising a plurality of system nodes; obtaining an inventory of all data objects in the distributed computer system; collecting metadata regarding each of the data objects; based on the metadata, applying a trained classification model to assign each of the data objects into one of a set of categories of data objects, based on a predicted likelihood that each data object will be accessed within a predefined time window; generating, based on the assigning, a graphical data object summary and security configurator which allows for centrally applying differential security controls profiles to each of the categories of data objects; and using the data object summary and security configurator to apply a specified the security controls profile to a respective one of the categories, wherein the security controls profile applies to all data objects assigned to the respective category.

There is also provided, in an embodiment, a system comprising at least one hardware processor; and a non-transitory computer-readable storage medium having stored thereon program instructions, the program instructions executable by the at least one hardware processor to: operationally connect to a distributed computer system comprising a plurality of system nodes, obtain an inventory of all data objects in the distributed computer system, collect metadata regarding each of the data objects, based on the metadata, apply a trained classification model to assign each of the data objects into one of a set of categories of data objects, based on a predicted likelihood that each data object will be accessed within a predefined time window, generate, based on the assigning, a graphical data object summary and security configurator which allows for centrally applying differential security controls profiles to each of the categories of data objects, and use the data object summary and security configurator to apply a specified the security controls profile to a respective one of the categories, wherein the security controls profile applies to all data objects assigned to the respective category.

There is further provided, in an embodiment, a computer program product comprising a non-transitory computer-readable storage medium having program instructions embodied therewith, the program instructions executable by at least one hardware processor to: operationally connect to a distributed computer system comprising a plurality of system nodes; obtain an inventory of all data objects in the distributed computer system; collect metadata regarding each of the data objects; based on the metadata, apply a trained classification model to assign each of the data objects into one of a set of categories of data objects, based on a predicted likelihood that each data object will be accessed within a predefined time window; generate, based on the assigning, a graphical data object summary and security configurator which allows for centrally applying differential security controls profiles to each of the categories of data objects; and use the data object summary and security configurator to apply a specified the security controls profile to a respective one of the categories, wherein the security controls profile applies to all data objects assigned to the respective category.

In some embodiments, the set of categories includes at least the following categories: (i) active, indicating a respective the data object that is likely to be accessed within a predefined time window, and (ii) inactive, indicating a respective the data object that is unlikely to be accessed within the predefined time window.

In some embodiments, the prediction model is trained on a training dataset comprising a plurality of feature sets, each representing the metadata collected over a predefined time window with respect of each of the data objects, and wherein each of the feature sets is labeled with a label indicating user access instances with respect to the respective data object occurring subsequently to the defined time window.

In some embodiments, the metadata comprises, with respect to each of the data objects, historical access and usage data comprising one or more of the following: times of access instances; count, frequency and recency of access instances; identity of accessing users; and types of access instances.

In some embodiments, the connecting, obtaining, collecting, applying and generating is performed continuously or recurrently with respect to the computer system.

In some embodiments, the method further comprises generating, and the program instructions are further executable to generate, a mapping which identifies a location of each of the data objects within the system nodes of the distributed computer system, and wherein the applying is based on the mapping.

In some embodiments, the system nodes comprise one or more of the following categories of nodes: a network, an on-premise data center, one or more endpoints, an enterprise file storage, a public cloud, a private cloud, or a blob storage.

In addition to the exemplary aspects and embodiments described above, further aspects and embodiments will become apparent by reference to the figures and by study of the following detailed description.

### BRIEF DESCRIPTION OF THE FIGURES

The present invention will be understood and appreciated more comprehensively from the following detailed description taken in conjunction with the appended drawings in which:

FIG. 1A depicts an exemplary distributed computing system.

FIG. 1B illustrates an exemplary distributed storage model which may be used in conjunction with a distributed computer system.

FIG. 2A is a graph that shows the gap between file permissions granted to users in an enterprise, and the actual usage profile of the file by the same users.

FIG. 2B depicts a similar case within an enterprise which implements active continuous mitigation of the exposure of a computer system or environment to malware attacks, by limiting and reducing the potential attack surface.

FIG. 3A depicts an exemplary data object summary panel providing a centralized graphical visualization of data objects within a distributed computer system comprising distributed storage.

FIGS. 3B-3C depict an exemplary centralized security configurator dashboard for a distributed computer system comprising distributed storage.

FIG. 4A is a block diagram of an exemplary system for dynamic centralized management and configuration of security policies and controls in a computer system.

FIG. 4B depicts an exemplary realization of the system shown in FIG. 4A.

FIG. 5A illustrates the functional steps in a method for dynamic centralized management and configuration of security policies and controls in a computer system.

FIG. 5B illustrates the functional steps in a method for training and inferencing a prediction model configured to output a classification which indicates a predicted activity status with respect to data objects in a computer system.

FIG. 6A provides an overview of a pipeline for training and inferencing a prediction model of the present technique.

FIG. 6B provides an overview of a pipeline for continuous or recurrent inferencing and updating a prediction model of the present technique.

### DETAILED DESCRIPTION

Disclosed herein is a technique, embodied in a system, method, and computer program product, for dynamic centralized management and configuration of security policies and controls in a computer system.

In some embodiments, the present technique provides for dynamic centralized management and configuration of security policies and controls with respect to data objects in a distributed computer system. In some embodiments, the present technique provides for centralized application and modification of security policies and controls to individual data objects, and/or to entire categories or classes of data objects, across the distributed computer system.

For purposes of this disclosure, the terms ‘data object,’ ‘data item,’ and/or ‘data asset’ refer interchangeably broadly to any constituent data units of a computer system, including any files, file directories, user directories, databases, data storage or repositories, computer sub-systems, external computer systems, storage devices, software programs or applications, websites, users, groups, end-devices, servers, network nodes, storage nodes, and the like.

For purposes of this disclosure, the term ‘metadata’ with reference to a data object, refers broadly to any attributes, information, data points and statistics associated with data objects in a computer system, including, but not limited to, system metadata and data object access and usage data.

For purposes of this disclosure, the terms ‘security controls’ and/or ‘security policies’ refer broadly to any technical and administrative safeguards that enforce protection of data objects in computer systems against potential misuse and threats, including, but not limited to, access controls, encryption controls, audit and logging controls, data integrity controls, and/or network controls.

Distributed computer systems comprise large numbers of heterogeneous nodes, which may run on multiple cloud platforms over different operating systems (e.g., Linux vs. Windows), hardware architectures, or software stacks. This heterogeneity often requires tailored security configurations, because a security profile compatible with one node might break functionality on another. Distributed systems are often also elastic, with nodes scaling up/down automatically or undergoing frequent updates. Thus, configurations can drift over time, requiring local or ad-hoc fixes which alter settings without centralized oversight.

In some embodiments, the present technique provides for a centralized security configurator, which may be implemented as a dashboard for administrators, which serves as a single point of control for defining, applying, and enforcing security policies across all nodes of a distributed computer system. Using the present centralized security configurator, administrators can define and apply policies centrally, which are then propagated in a consistent and uniform manner across all nodes of the system.

In some embodiments, the present centralized security configurator allows administrators to apply security policies and controls centrally to entire classes or categories of data objects (e.g., based on a classification scheme which classifies data objects based on their likelihood of access or usage by system users), regardless of their type or actual storage location within the distributed system. This permits administrators to define and apply security controls based on conceptual, logical, or functional groupings of data objects, rather than based on location or other technical details. This also means that security policies and controls applied centrally to entire classes or categories of data objects, will continue to apply based on the logical or functional requirements, even as the distributed system elastically grows or changes over time.

For example, this may allow administrators to apply differential security controls across the entire distributed system, by grouping data objects based, e.g., on their predicted future likelihood of usage or access. This is enabled by a classification process which classifies all data objects in the system based on their access likelihood within defined time windows. The security controls are then applied to all constituent data objects in each group or class based on the classification results, regardless of their type or location within the system.

Furthermore, the classification process can operate continuously, recurrently or periodically (e.g., hourly, daily), to constantly reevaluate the category assignment of each data object. With each iteration of the classification process, as data objects migrate through categories, they automatically inherit the security profile of their new category, without requiring manual policy updates. This simplifies security administration, by allowing administrators to define controls on the basis of logical categories, which automatically apply to all objects in that category, regardless of how many objects migrate in and out periodically. This also supports scalability, as new data objects are placed into categories by the classification process, and automatically inherit the security controls associated with their classification. This capability also promotes consistency and standardization of security policies across heterogeneous, distributed, and multi-cloud environments; allows for changing of platforms or underlying technology without rebuilding security rules; and reduced complexity and allows for faster deployment and easier management.

In distributed environments, security gaps often emerge from configuration drift, where different nodes apply different rules over time. The present centralized configurator prevents this by enforcing uniform policies. This is particularly crucial in regulated industries, as auditors can verify that security controls are universally applied rather than checking each system individually. Without centralization, security changes require coordinating updates across a large number of nodes (potentially thousands). The present centralized configurator can help to reduce this task to a single administrative action, which promotes efficiency and immediacy of response across the entire infrastructure. In addition, the present configurator provides a complete view of what security policies exist and how and where they are applied. This provides for transparency which is essential for security assessments, incident response, and ongoing monitoring.

In some embodiments, centralized application and modification of security policies and controls across entire categories or classes of data objects may be based on any desired or suitable categorization scheme which assigns data objects to one or more meaningful categories or classes. For example, data objects within a distributed computer system may be classified on the basis of geographic location, storage type (e.g., on-premise, private cloud, public cloud, etc.), data object type, applicable regulatory regime, applicable privacy controls, etc., and/or any combination of these categories.

In one case, data objects within a distributed computer system may be classified on the basis of their predicted activity status over a predefined time window, e.g., likelihood that each data object will be accessed and/or used by system users within a certain near-term time window. Accordingly, the present technique may provide for centrally applying differential security controls to data objects in a centralized manner, based on their classification as ‘active’ or ‘inactive.’ For example, ‘active’ objects may be subject to less stringent security controls, to facilitate ease of access, collaboration and productivity. The rationale is that ‘active’ data objects having a high likelihood of near-term access are expected to constitute a relatively small percentage of the total, and therefore, applying somewhat relaxed security controls can help to avoid productivity bottlenecks while not increasing significantly the attack surface of the system overall. Conversely, ‘inactive’ data objects (expected to be a significantly larger class) may have more stringent security controls applied thereto, because the low usage likelihood reduces the need for easier access, thereby reducing the overall attack surface of the system as a whole.

A potential advantage of the present technique is, therefore, that it provides for centralized dynamic and elastic application and modification of security policies and controls across entire categories or classes of data objects within a distributed computer system. This promotes uniformity and reduces inconsistencies in the application of security control configurations to data objects within each category, which in turn enhances overall system security and reduces its potential attack surface.

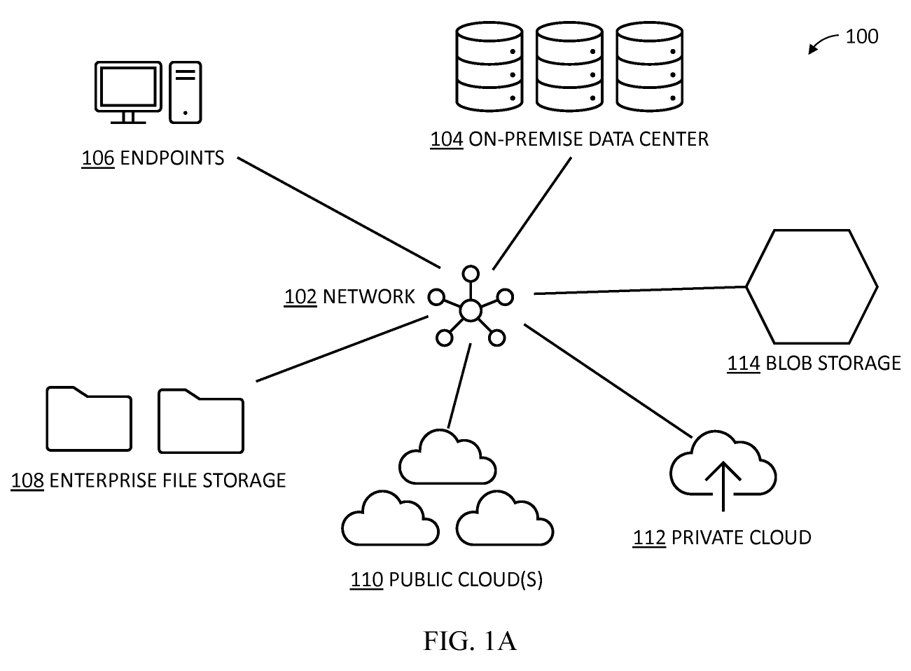

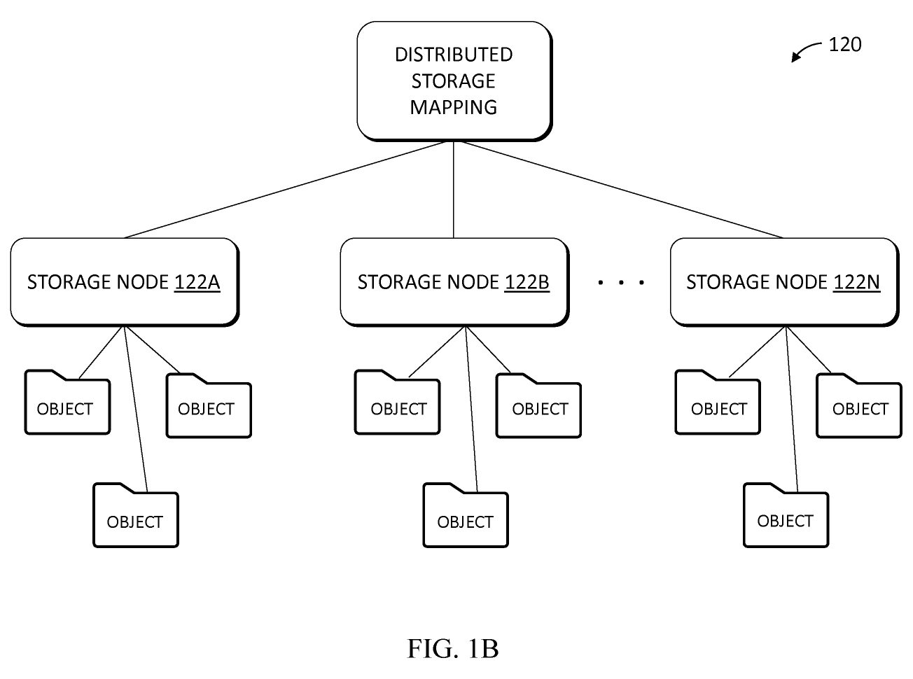

FIG. 1A depicts an exemplary computer system 100, in which the present technique for dynamic centralized management and configuration of security policies and controls in a computer system may be realized.

In some embodiments, computer system 100 may be any private, enterprise, governmental agency, healthcare facility, or similar computer system or environment. In some embodiments, computer system 100 comprises such elements as:

A network 102 which interconnects the various nodes of distributed computer system 100 and provides access to the stored data therein. Network 102 may comprise one or more interconnected private and public networks, including, but not limited to, a local area network (LAN), a virtual network, such as Microsoft Azure Virtual Network or similar, and/or the Internet.

An on-premise data center 104.

One or more endpoints 106 such as workstations, laptops, and mobile devices.

Enterprise file storage 108.

One or more public clouds 110.

A private cloud 112.

A blob storage 114.

However, in other cases, computer system 100 may comprise fewer, additional, and/or other different components and elements.

In some embodiments, distributed computer system 100 may comprise a distributed model, such as exemplary distributed storage model 120 illustrated in FIG. 1B. Distributed storage 120 may be organized as an arbitrary plurality of storage nodes 122A-122N accessible to users of distributed computer system 100 according to a configurable data access plan. Each storage node 122 may in turn be configured to store an arbitrary plurality of data objects.

In some embodiments, computer system 100 is a distributed or decentralized computer system, where data objects are stored or reside in more than one location or node, including proprietary on-premise and remote data centers, private cloud, and/or public cloud and similar platforms. In some cases, distributed storage 120 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding schema, such that the object data may be recreated from all or some of the generated portions, wherein the generated data object portions may be stored respectively in one or more storage nodes 122A-122N.

In some embodiments, distributed storage 120 may generate and store a mapping between data objects and storage nodes 122A-122N, which identifies a location of each data object within the plurality of storage nodes 122A-122N.

In some embodiments, computer system 100 may comprise one or more of the following categories of nodes and platforms:

Traditional Network-Attached Storage and File ServersThese provide block-level or file-level storage over network file protocols, designed for shared file access. Examples include NetApp Filer, Windows File Server, and AWS EFS.

Object StorageImmutable key-value stores accessed via REST/HTTPS. No hierarchy beyond prefixes. Examples include S3 Bucket, Azure Blob Storage, and Amazon Glacier.

Cloud Data WarehouseServerless, columnar data warehouse, such as Snowflake.

Relational Database: Open-source row/columnar relational databases, such as PostgreSQL.

Enterprise Content ManagementDocument-centric storage includes document libraries, versioning, metadata, and personal cloud file sync and share. Examples include SharePoint, Office 365, and OneDrive.

Unified Storage ArraysSuch as Dell EMC.

Endpoint Detection and Response (EDR)Cloud-native EDR platform, such as CrowdStrike Falcon.

As noted above, enterprises handling data via a distributed computer system (e.g., collecting, receiving, transmitting, storing, processing, sharing, accessing, and/or modifying data objects) may desire to perform actions on the data objects in a centralized manner. This may involve having to discover and locate each of the data objects over the distributed computer system, classify the data objects into one or more meaningful, conceptual or logical classes or categories, and centrally apply policies and/or perform actions with respect to the data objects on an individual and/or class or category basis. As the system scales with more nodes or users, such a centralized functionality may help to enforce uniform security controls and policies across all nodes and platforms based on the logical or functional classification, regardless of data object type or storage location.

Accordingly, in some embodiments, the present technique provides for operationally connecting to a target computer system, to conduct an initial forensic scan to create an inventory of all data objects in the computer system. In some embodiments, after the initial forensic scan, the present technique provides for continuous, recurrent or periodic forensic scans to update the created inventory with any changes to data objects in the computer system. In some embodiments, such continuous, recurrent or periodic forensic scans may be performed according to nay desired to suitable schedule, for example, hourly, daily, weekly, bi-weekly, etc.

In some embodiments, the forensic scan comprises a data object discovery stage to discover, locate, catalog, and create an inventory and mapping of all data objects in the target computer system. In some embodiments, the data object discovery stage may be performed by a client application that is native to the target computer system. However, in other cases, the data object discovery stage may be performed by an external computer system (e.g., a data discovery system) which may operationally connect to the target computer system via a public or private data network, and deploy a client application to perform the data discovery process.

In some embodiments, the present technique then provides for collecting metadata and related information with respect to historic and current usage of data objects in computer system, including, but not limited to, data object type, location, owner, author, main contributor(s), data object access and modification permissions, object access instances history (including, e.g., count, frequency, recency, and time of access instances, accessing user, type of access instances—read/write/modify), and events associated with data access instances. In some embodiments, the present technique may be configured to collect the information with respect to usage of data objects in the created inventory continuously, recurringly or periodically, for example, hourly, daily, weekly, bi-weekly, etc.

In some embodiments, the present technique may then provide for classifying the discovered data objects within the target computing system into one or more meaningful classes or categories, based on any desired or suitable categorization schema. For example, data objects may be categorized on the basis of geographic location, storage type (e.g., on-premise, private cloud, public cloud, etc.), data object type, applicable regulatory regime, applicable privacy controls, etc., and/or any combination of these categories.

In one example, the present technique provides for classifying all data objects in a target distributed computing system, into classes or categories based on predicted activity status. Accordingly, in some embodiments, the present technique provides for classifying each data object within the target computing system into a set of predetermined classes of data objects, based, at least in part, on categorizing each of the data objects according to its predicted activity status. In some embodiments, categorizing each of the data objects within the target computer system according to its predicted activity status is based on establishing a predicted activity status with respect to each of the data objects in the distributed computer system. In some embodiments, establishing a predicted activity status with respect to each of the data objects in the distributed computer system indicates the likelihood that any such data object will be used and/or accessed within a predefined time window, such as within the next hour, day, 7 days, 14 days, 30 days, or any other desired or suitable period of time.

In some embodiments, the steps of data object scan, discovery stage, metadata collection, and data object classification may be repeated continuously, recurringly or periodically, e.g., hourly, daily, weekly, bi-weekly, monthly, or according to any desired recurring schedule.

In some embodiments, the present technique then provides for real-time dynamic centralized graphical visualization of all data objects discovered, located and cataloged within the target computer system, according to their predicted activity status. Thus, in some embodiments, the present technique then provides for real-time dynamic centralized graphical visualization of all data objects discovered, located and cataloged within the target computer system, based on one or more of the following exemplary activity classes or categories:

Active Data ObjectThese are ‘live’ data objects that have a high likelihood of being used and/or accessed on a read/write/modify basis by at least one system user within the predefined time window.

Read-Only Data ObjectThese are data objects that are likely to be used and/or accessed on a read-only basis by at least one system user within the predefined time window.

Inactive Data Object these are dormant or ‘cold’ data objects, that are unlikely to be used and/or accessed by any system user within the predefined time window.

Routine Maintenance The data object likely to be used and/or accessed for periodic or routine system maintenance or for similar purposes within the predefined time window.

In some embodiments, the centralized graphical visualization of all data objects, based on placing each data object into one of a set of classes or categories, may then further provide for centralized management and configuration of security policies and controls in the target computer system. For example, in some embodiments, the present technique provides for centralized application and modification of security policies and controls across categories or classes of data objects within the target distributed computer system, based on classifying data objects in the system into one of a set of classes or categories.

Thus, in some embodiments, categorizing and classifying all data objects within a target computer system according to activity status allows system administrators to centrally apply differential security policies and controls and related configurations to entire categories or classes of data objects, based on their class or category, regardless of type or storage location within the distributed computer system.

For example, data objects predicted as likely to be used and/or accessed on a read/write/modify basis by at least one user within the predefined time window, may be designated as ‘active’ data objects. Such ‘active’ data objects may be stored in a dedicated storage cache, that is secure, scanned for malware, and virtually air-gapped from the rest of the data.

In some embodiments, ‘active’ data objects represent a small percentage (e.g., between 2-4%) of the total data objects within the target computer system. System administrators may apply centrally to all ‘active’ data objects identical predetermined security policies and controls, which define access and usage parameters with respect to these data objects. These security policies and controls will be applied to all such data objects in this class across the board, regardless of their type or exact location within the distributed computer system.

For example, these ‘active’ data objects may be subject to less stringent security controls, to facilitate ease of access, collaboration and productivity. The rationale is that data objects having a high likelihood of access and usage are expected to constitute a relatively small percentage of the total (e.g., 2-4% of the total number of data objects), and therefore applying somewhat relaxed security controls can help to avoid productivity bottlenecks while not increasing significantly the attack surface of the system overall.

Conversely, data objects categorized as unlikely to be used and/or accessed on a read/write/modify basis by at least one user in the target computer system within the predefined time window, may be designated as ‘inactive’ or ‘read-only’ data objects. These data objects typically represent a much larger proportion (e.g., between 96-98%) of the total data objects within the target computer system. Thus, they may be subject to enhanced or stricter security controls, because the low usage likelihood reduces the need for easier access, thereby reducing the overall attack surface of the system as a whole.

For example, because ‘inactive’ data objects are not likely to be accessed within the specified time window, they may be subject to enhanced security measures or protocols which will improve overall system security and reduce its potential attack surface, without creating unnecessary burdens for users. For example, in some cases, a data object designated as ‘inactive’ may be subject to modified access protocols, which may require, for example, multi-factor authentication (MFA) to access the data object, or to have read and/or write privileges with respect to the data object. In some cases, a data object designated ‘inactive’ may be designated as read-only, thereby eliminating write access to these data objects, which reduces the risk that these data objects will be encrypted in a ransomware attack. In other cases, a data object designated ‘inactive’ may be subject to modified read and/or write permissions that are limited to only those users which have active authorization to use such data object, and have in fact accessed such data object within a recent specified period.

Accordingly, in some embodiments, the present technique provides for a data object discovery stage of a target computer system, such as exemplary distributed computer system 100 and distributed storage model 120. In some embodiments, data object discovery may be based on a forensic scan of distributed computer system 100 configured to discover, locate, catalog, and create an inventory and mapping of, all data objects in distributed computer system 100. In some embodiments, the asset discovery stage may be performed by a client application that is native to distributed computer system 100. However, in other cases, the asset discovery stage may be performed by an external computing system (e.g., a data discovery system) which may operationally connect to distributed computer system 100 via a public data network, and deploy a client application to perform the data discovery process.

The data object discovery stage may generate and store metadata for each of the data objects discovered within distributed computer system 100, that indicates, for example, data object type, location, owner, author, main contributor(s), object access history (including, e.g., time of access, accessing user, type of access (read/write/modify), associated events preceding data access), and data object access and modification permissions. In some embodiments, the present technique then provides for real-time dynamic centralized graphical visualization of all data objects discovered, located and cataloged within distributed computer system 100.

In some embodiments, the forensic scan may generate a mapping of all data objects within distributed computer system 100, which provides an indication with respect to the location of each data object within the various storage nodes 122A-122N of distributed storage 120. In some embodiments, the mapping generated by the forensic scan comprises, with respect to each data object, metadata with respect to one or more replicas of the data object, and/or metadata with respect to data objects with are divided into a number of portions according to an encoding schema and stored over two or more different storage nodes 122A-122N.

In some embodiments, the collected metadata may be used to classify or categorize all data objects in distributed computer system 100 into classes or categories, based on any desired or suitable categorization schema, e.g., on the basis of geographic location, storage type (e.g., on-premise, private cloud, public cloud, etc.), data object type, applicable regulatory regime, applicable privacy controls, etc., and/or any combination of these categories.

In some embodiments, the collected metadata and related information may be used to train a dedicated machine learning prediction model, to output a classification which indicates, with respect to each of the data objects in the computer system, the likelihood that such data object will be used and/or accessed within a predefined time window, e.g., within the next hour, day, 7 days, 14 days, 30 days, or any other desired or suitable period of time.

In some embodiments, the trained prediction model may be continuously, recurringly or periodically refined or re-trained using updated data object inventory and metadata collected continuously, recurringly or periodically with respect to the data objects in the computer system. In some embodiments, the classification model may be recalibrated by refining category boundaries based on observed access patterns, organizational changes, new projects, or system migrations.

In some embodiments, the prediction model is trained to output a binary classification (i.e., 0/1, or yes/no) which indicates, with respect to each of the data objects in the computer system, whether or not it is likely to be used and/or accessed within the predefined time window.

In other cases, the prediction model is trained to output a multi-class classification, which assigns each data object to of a set of predetermined classes. In one example, such set of classes may comprise, but is not limited to, the following classes:

Class I: Data object is active and likely to be accessed on a read/write/modify basis within the predefined time window. This prediction may indicate globally, with respect to all authorized users of a data object, that the data object is active and is likely to be used and/or accessed within the predefined time window. Alternatively, this prediction may indicate separately, with respect to each user of a data object, whether the data object is active and likely to be used and/or accessed by such authorized user within the predefined time window. Data objects included in this category are currently open files, recently modified objects, frequently queried database records, and data in active workflows. Active data typically requires the fastest storage media and lowest functional barriers to access.

Class II: This class may include moderately-active data that are accessed occasionally, such as recently completed projects, periodic reports, or seasonal business data.

Class III: This class may include data objects that are expected to be accessed on a read-only basis, and are not expected to be modified or edited by users.

Class IV: Inactive or infrequently accessed data with low probability of access in the near term. This class may include historical records, archived emails, or completed audit files.

Class V: Extremely rarely accessed data retained primarily for long-term preservation, legal holds, or compliance requirements.

Class VI: Data object is inactive, and is likely to be accessed only for periodic system maintenance or similar purposes within the predefined time window.

In some cases, the set of classes may include intermediate categories, and may be tailored to the need of specific organizations of industries.

In a typical enterprise computer system or environment, the trained prediction model is expected to classify between 2-4% of the total data objects in the computer system as ‘active’ i.e., data objects which are likely to be used and/or accessed on a read/write/modify, read-only or for maintenance purposes within the predefined time window. The trained prediction model is thus expected to classify the balance of the data objects in the computer system (between 96-98% of the total) as ‘inactive,’ i.e., as data objects which are unlikely to be used and/or accessed on a read/write/modify basis within the predefined time window.

In the case that the prediction model is trained to output a binary classification (i.e., 0/1, or yes/no), the balance of the data objects (between 96-98% of the total) will be classified as ‘inactive,’ i.e., as data objects which are unlikely to be used and/or accessed on a read/write/modify basis within the predefined time window.

In the case that the prediction model is trained to output a multi-class classification as per the example given immediately above, the balance of the data objects in the computer system, i.e., between 96-98% of the total, will be classified as one of, as the case may be: data object likely to be used and/or accessed on a read-only basis; data object unlikely to be used or accessed; and/or data object likely to be used and/or accessed for periodic system maintenance or similar purposes only.

In some embodiments, the present technique may then provide for caching those data objects classified as ‘active,’ i.e., likely to be used and/or accessed on a read/write/modify basis within the predefined time window, in a dedicate storage cache, that is secure, scanned for malware, and virtually air-gapped from the rest of the data. In some embodiments, the active data objects are made available for access over the predefined time window. In some embodiments, such data objects are made available for access using the standard login or permission protocols in use by the computer system.

In some embodiments, the secure cache may be an immutable storage which cannot be altered, deleted, or modified, to ensure data integrity and protection against threats like ransomware, accidental deletions, or malicious tampering. In some embodiments, the secure cache provides for tamper-proof storage which protects against unauthorized changes, including those by insiders or external threats like ransomware. In some embodiments, the secure cache may employ one or more of the following specific technologies and processes to ensure data integrity and protection:

Air-Gapped Storage: Data may be stored offline or in isolated environments to further protect against network-based attacks.

WORM Storage: Data may be stored in a WORM (write once, read many) format that ensures data can only be written once and cannot be altered or deleted after that initial write.

Data Object Lock: In cloud storage (e.g., AWS S3, Azure Blob Storage), an ‘object lock’ feature can enforce immutability by preventing changes or deletions to objects for a set period.

Encryption: Data may be encrypted to enhance security.

In some embodiments, the secure cache may be based, at least in part, on hardware-based solutions, such as tape storage with WORM capabilities or dedicated immutable cache appliances from vendors such as NetApp or Dell EMC. In some cases, the secure cache may be based, at least in part, on features and technologies offered by cloud provides, such as AWS S3 Object Lock, Azure Blob Storage Immutable Storage, Google Cloud Storage Lock, and the like. In other cases, the secure cache may be based, at least in part, on storage software solution, such as Veeam, Rubrik, Cohesity, Commvault, and the like.

The secure cache ensures that, in the event of a ransomware attack, critical active data objects remain accessible, thereby maintaining business continuity. Because the secure cache represents a small fraction of the total volume of data (e.g., 2-4%), it significantly reduces the resources required for data storage and backup, compared to traditional solutions. The relatively small size of the cache further allows measures that are difficult to implement when dealing with larger volumes of data—rigorous scanning against malware, reduced penetrability and attack surface, machine learning-based encryption testing, versioning in case of encryption suspicion, as well as frequent restore tests. The restore tests can be used to ensure the integrity and non-encrypted status of the cached data, as well as enable quick and efficient recovery exercises that are not feasible with larger data volumes typically associated with conventional backup systems.

In some embodiments, the present technique further provides for designating all other data objects, i.e., those classified as unlikely to be used and/or accessed on a read/write/modify basis within the predefined time window, as ‘inactive’ data objects (representing between 96-98% of the total volume of data). In some embodiments, data objects designated as inactive may be subject to enhanced security measures or protocols. For example, in some cases, a data object designated inactive may be subject to modified access protocols, which may require, for example, multi-factor authentication (MFA) to access the data object, or to have read and/or write privileges with respect to the data object. In some cases, a data object designated inactive may be designated as ‘read only,’ thereby eliminating write access to these data objects. Designating inactive data objects as ‘read only’ reduces the risk that these data objects will be encrypted in a ransomware attack. In other cases, a data object designated inactive may be subject to modified read and/or write permissions that are limited to only those users which have active authorization to use such data object, and have in fact accessed such data object within a recent specified period.

In some embodiments, this classification schema is based on the insight that, after being generated and after an initial period of activity, data objects in a typical enterprise or similar computer system may become dormant or inactive, or otherwise infrequently accessed or used. At the same time, such data objects may be subject to ‘permission drift,’ where an increasing number of people are awarded or retain privileges with respect to the data object, where no actual business need exists for granting and maintaining such permissions. The existence of a very large pool of data objects with a wide permissioning base significantly increases the potential attack surface of the computer system.

Common cybersecurity tools have typically managed access control by focusing on identity management, that is, the identity of the individuals within the organization that are granted access to which file. However, identity-based access management requires an intricate and cumbersome process of identity, time, and geographic policy management. The complexity of managing identities and access rights is a well-documented challenge in the cybersecurity industry, and traditional systems often require extensive resources and constant oversight to maintain an accurate and secure access control framework.

Conversely, the present technique manages data object access on a time-based approach, built on the principle that access should be aligned with the needs and schedules of the data or resources in question. This means that permissions are dynamically modified day-to-day, based on a predicted need to use each data object, rather than based on the identity of the user. Thus, the present technique does not attempt to discern which user should be able to access any piece of data, but rather dynamically predicts, on an ongoing basis, whether the data object is actually likely to be accessed by any of its authorized users. This proactive approach allows the system to adjust permissions and access rights in real-time, without the need for manual intervention by system administrators.

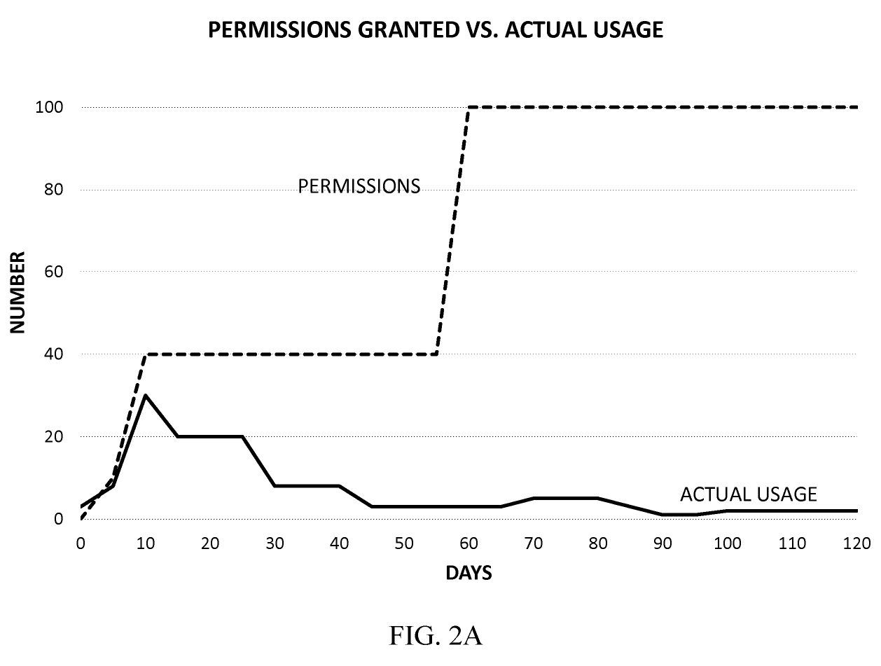

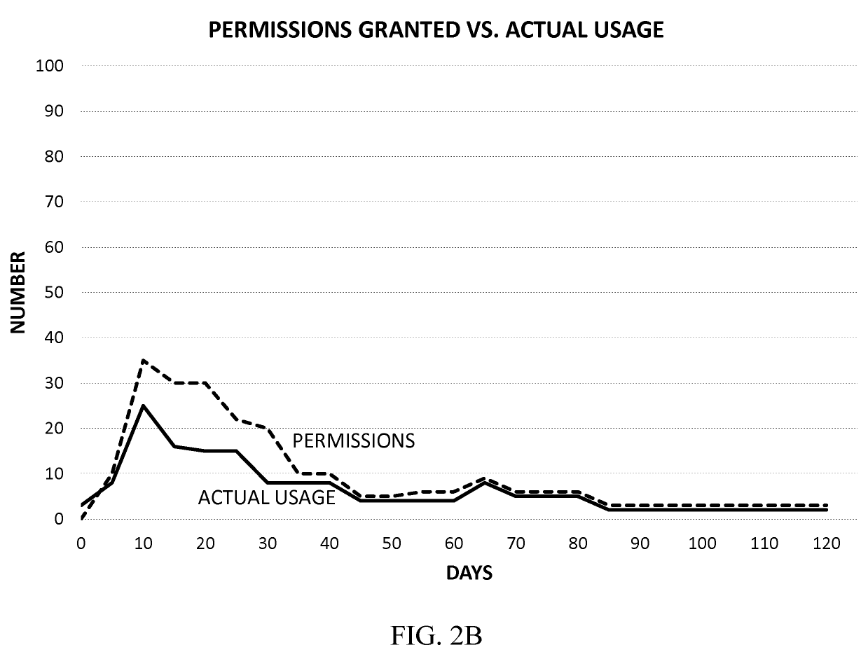

FIG. 2A depicts such an exemplary case of permission drift over the life of a data object, where the dashed line represents the number of access privileges granted over time with respect to a data object, and the solid line represents the number of actual instances of access to the data object over time.

An enterprise data object, e.g., a document, a file, or the like, may be crated on day one, by one or more initial users. In the next 2-3 days, the initial users may invite a handful of other users within the enterprise to review and comment on the created document. On day 10, the invited reviewers may in turn share the document with multiple other users, of which only a portion will actually access and/or edit the document. Over the first month, the document is gradually finalized, and the authorized users generally do not need to access or modify it any longer. However, the permissioning status quo is maintained and the permissions already granted typically are not withdrawn, despite there being no further business need to maintain them. Furthermore, on day 60, the document may be moved to another directory or location, for example, as part of system clean up. In the new location, the data object may inadvertently inherit the user-permissions structure associated with that new location. Suddenly, numerous additional users gain access to the document, even though it is no longer an actively-used document, and the likelihood that any of these users will need to access it is small. The large number of users with redundant privileges for this document represent an increased risk that the document may be impacted in case of a ransomware or similar attack. In the other hand, managing permissioning for the document now becomes a challenging and time-consuming process.

FIG. 2B depicts a similar case within an enterprise in which the present technique for active continuous mitigation of the exposure of a computer system or environment to malware attacks, by limiting and reducing the potential attack surface, is implemented. The dashed line represents the number of access privileges granted over time with respect to a data object, and the solid line represents the number of actual instances of access to the data object over time.

As can be seen, an enterprise data object, e.g., a document, a file, or the like, may be created on day one, by one or more initial users. In the next 2-3 days, these initial users may invite several other users within the enterprise to review and comment on the created document. On day 10, the invited reviewers may in turn share the document with multiple other users, of which only a portion actually access and/or modify the document.

During this period, a trained prediction model of the present technique may recurringly or periodically monitor the document, to predict the likelihood that each of the authorized users will access the document within the predefined time window (e.g., within the next 14 days). While the prediction model determines that at least one authorized user is likely to access the within the predefined time window, the document retains its ‘active’ designation, and may be moved to a dedicate secure storage cache for active data objects. In such case, the data object will be subject to security and permissioning controls applied to the ‘active’ class of data objects, and may remain available for access by its authorized users over the predefined time window, e.g., using the standard login or permission protocols in use by distributed computer system 100. In some embodiments, the prediction model may determine that one or more of the authorized users are unlikely to access the document within the predefined time window. The prediction model may then modify (e.g., to require MFA to access the document) or revoke the authorization of such users.

Over the first month, the document is gradually finalized, and the authorized users do not need to access or modify it any longer. The prediction model may recurringly or periodically monitor the relevant document (e.g., hourly, daily, etc.), to predict the likelihood that each of the authorized users will access the document within the predefined time window (e.g., the next 14 days). When the prediction model determines that none of the authorized users is likely to access the document within the predefined time window, the prediction model may classify the document as an ‘inactive’ data object. In such case, the data object will be subject to security and permissioning controls applied to the ‘inactive,’ which may require enhanced security and access controls. For example, in some cases, a data object designated inactive may be subject to modified access protocols, which may require multi-factor authentication (MFA) to access the data object, or to have read and/or write privileges with respect to the data object. As can be seen, this approach keeps the access permissions for the document in line with its actual predicted usage, and thus permission drift is prevented. The data object in question is removed from the pool of objects that represent the potential attack surface for the organization, thus reducing overall risk, without the need for intricate identity-based security and permissioning management.

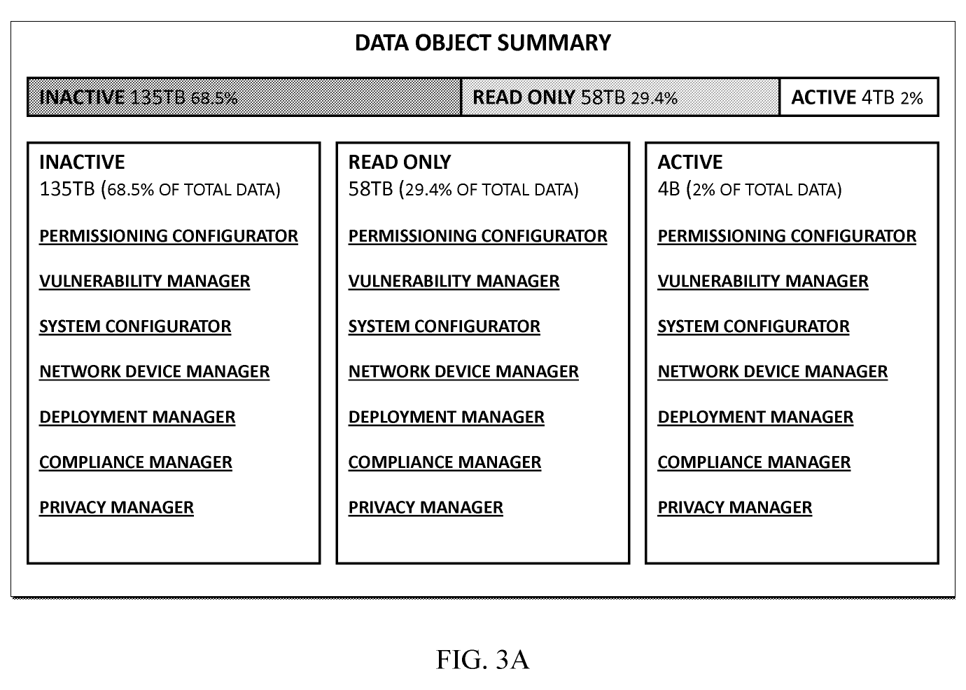

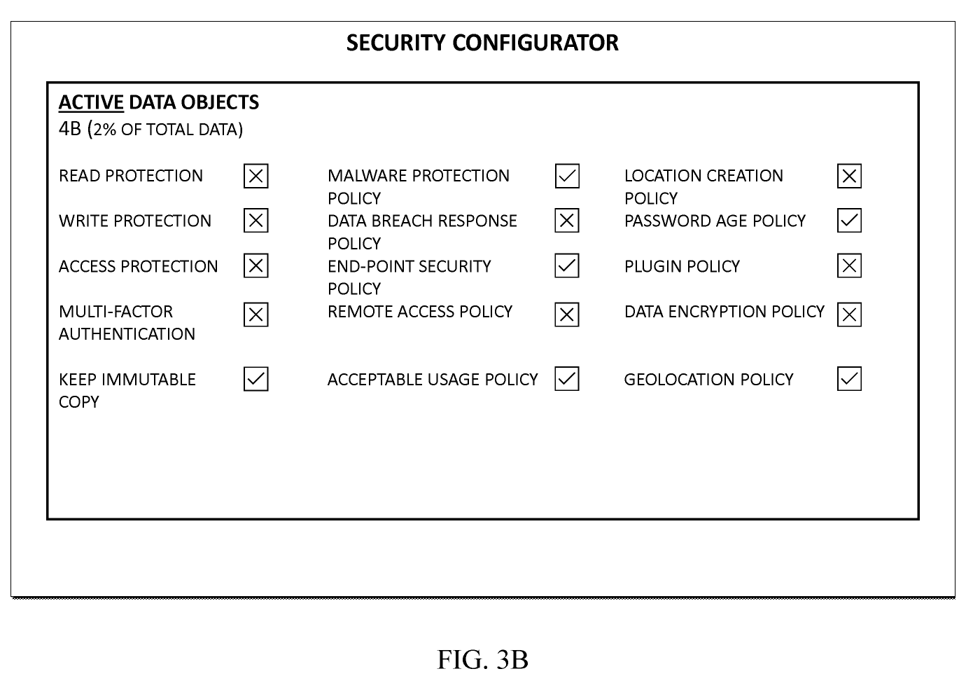

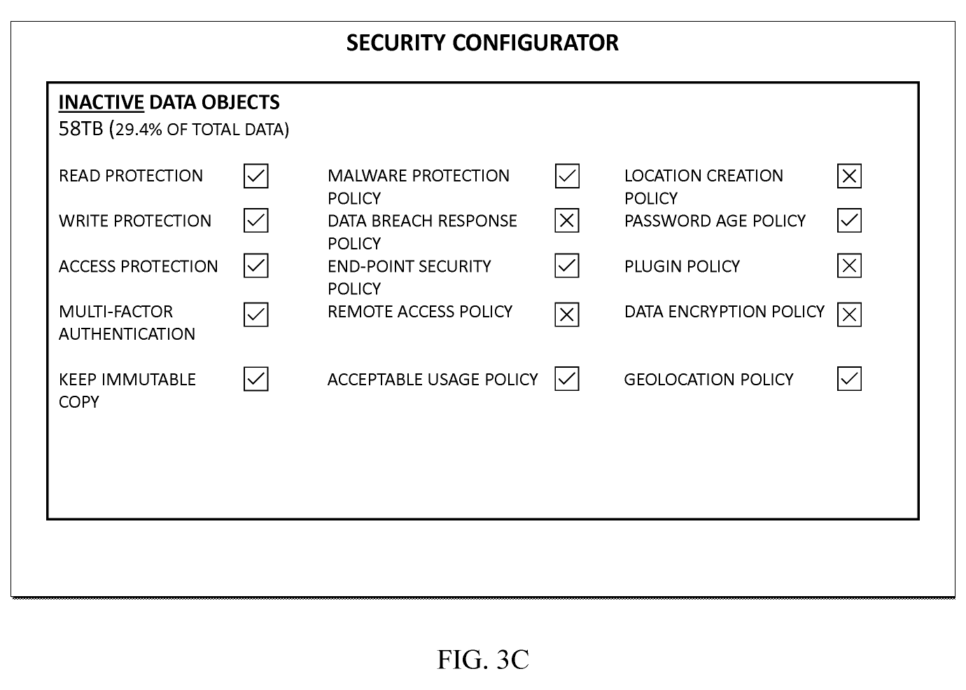

FIG. 3A depicts an exemplary data object summary panel providing centralized graphical visualization of all data objects or objects discovered, located and cataloged within a target computer system, such as distributed computer system 100.

In some embodiments, the data object summary panel presents a dynamic centralized graphical visualization of all data objects within the distributed storage scheme of distributed computer system 100, according to their assigned category or class.

For example, the data object summary panel may present a centralized graphical visualization of all data objects across all distributed storage nodes 122A-122N within distributed computer system 100, based on their predicted activity status. As can be seen in the example of FIG. 3A, the data object summary panel may provide visual and numerical indication of the total number or proportion of data objects within each of the classification categories. Thus, the data object summary panel visually presents the output results of a trained prediction model of the present technique, configured to output a classification which indicates, with respect to each of the data objects in distributed computer system 100, the likelihood that such data object will be used and/or accessed by an authorized user within a predefined time window, such as within the next 7 days, 14 days, 21 days, 30 days, or any other desired period of time.

In the exemplary data object summary panel shown in FIG. 3A, the prediction results present the allocation of all data objects within distributed computer system 100 among three categories or siloes:

Active Data Object: These are ‘live’ data objects that are likely to be used and/or accessed on a read/write/modify basis by at least one system user within the predefined time window.

Read-Only Data Object: These are data objects that are likely to be used and/or accessed on a read-only basis by at least one system user within the predefined time window.

Inactive Data Object: these are dormant or ‘cold’ data objects, that are unlikely to be used and/or accessed by any system user within the predefined time window.

Routine Maintenance: The data object likely to be used and/or accessed for periodic or routine system maintenance or for similar purposes within the predefined time window.

However, in other cases, the prediction results may include fewer, more, different, or alternative classes or categories.

In some embodiments, the data object summary panel provides for centralized management and configuration of security policies and controls with respect to each of the classes or categories of data objects presented in the summary panel shown in FIG. 3A. For example, in each category, the data object summary panel provides for links to various management and configuration tools, such as a security configurator, a vulnerability manager, a system configurator, a network device manager, and the like.

For example, as can be seen in FIGS. 3B-3C, the data object summary panel may provide a link to a security configurator, which permits centralized management and configuration of security controls for each of the classification categories presented in the data object summary panel shown in FIG. 3A. Thus, in FIG. 3B, the security configurator permits centralized management and configuration of security controls which will be applied centrally to all data objects within distributed computer system 100 currently classified as ‘active,’ i.e., are likely to be used and/or accessed on a read/write/modify basis by at least one of its authorized users within the predefined time window. For example, the security configurator permits centralized management and configuration of security controls such as, but not limited to, read protection, write protection, access protection, multi-factor authentication, and the like.

Likewise, in FIG. 3C, the security configurator permits centralized management and configuration of security controls which will be applied centrally to all data objects within distributed computer system 100 currently classified as ‘inactive,’ i.e., are unlikely to be used and/or accessed on a read/write/modify basis by at least one of its authorized users within the predefined time window.

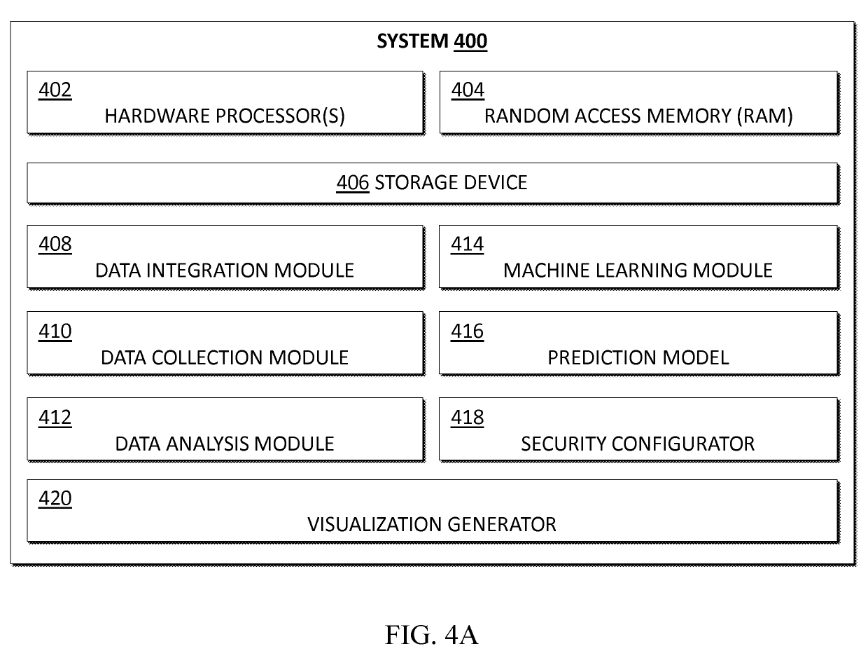

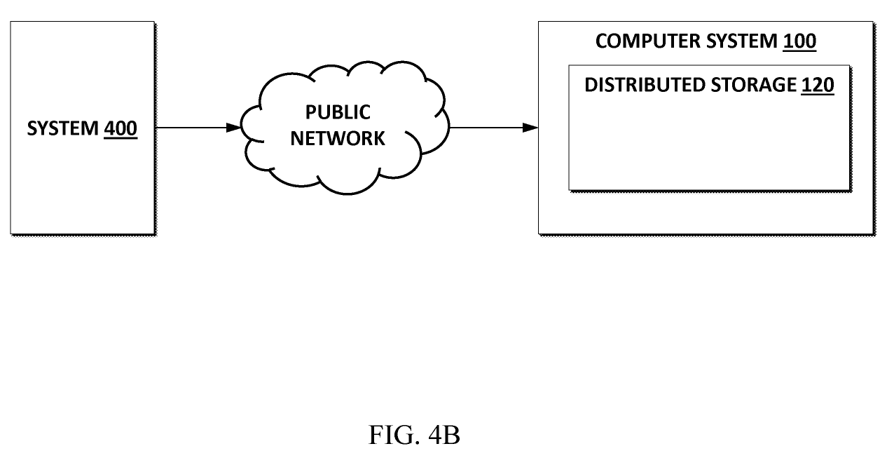

Reference is made to FIG. 4A, which is a block diagram of an exemplary system 400 for realizing the present technique for dynamic centralized management and configuration of security policies and controls in a distributed computer system.

In some embodiments, system 400 may comprise a hardware processor 402, a random-access memory (RAM) 404, and/or one or more non-transitory computer-readable storage device 406.

Hardware processor 402 may include components such as, but not limited to, one or more central processing units (CPUs), graphics processing units (GPUs), or any other suitable multi-purpose or specific processors or controllers. Hardware processor 402 may be operationally directly and/or indirectly connected to, and control the operation of, storage device 406 and all other components of system 400.

Storage device 406 may be or may include, for example, one or more non-transitory computer-readable storage device(s), a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units.

In some embodiments, system 400 may store in storage device 406 software instructions or components configured to operate a processing unit (also ‘hardware processor,’ ‘CPU,’ or simply ‘processor’), such as processing module 402. The software instructions may be any executable code, e.g., a software application, a program, a process, task or script. In some embodiments, the software components may include an operating system, including various software components and/or drivers for controlling and managing general system tasks (e.g., memory management, storage device control, power management, etc.) and facilitating communication between various hardware and software components.

The software instructions and/or components operating processing module 402 may comprise one or more modules, such as a data integration module 408, a data collection module 410, a data analysis module 412, a machine learning module 414, a prediction model 416, and/or a security configurator 418. These modules may be implemented in hardware only, software only, or a combination of both hardware and software.

In some embodiments, system 400 may further comprise a visualization generator 420 configured to generate and display a data object summary panel and a security configurator.

In some embodiments, system 400 may further comprise a display monitor for displaying data and images, a control panel for controlling system 400, and/or a speaker for providing audio feedback.

System 400 as described herein is only an exemplary embodiment of the present invention, and in practice may be implemented in hardware only, software only, or a combination of both hardware and software. System 400 may have more or fewer components and modules than shown, may combine two or more of the components, or may have a different configuration or arrangement of the components. System 400 may include any additional component enabling it to function as an operable computer system, such as a motherboard, data busses, power supply, a network interface card, a display, an input device (e.g., keyboard, pointing device, touch-sensitive display), etc. (not shown). Components of system 400 may be co-located or distributed, or the system may be configured to run as one or more cloud computing ‘instances,’ ‘containers,’ ‘virtual machines,’ or other types of encapsulated software applications, as known in the art.

In some embodiments, system 400 may comprise one or more software applications and/or hardware components that are native to a distributed computer system environment, such as distributed computer system 100, and may be operable to perform the steps of one or more methods of the present technique described herein with respect thereto. For example, system 400 may be realized as a client software application hosted on the target computer system and making use of its hardware and computational resources.

However, FIG. 4B depicts an exemplary realization in which system 400 is an external standalone computing system which may operationally connect to a target computing system, such as distributed computer system 100, via a public data network, to perform the steps of one or more methods of the present technique described herein with respect thereto.

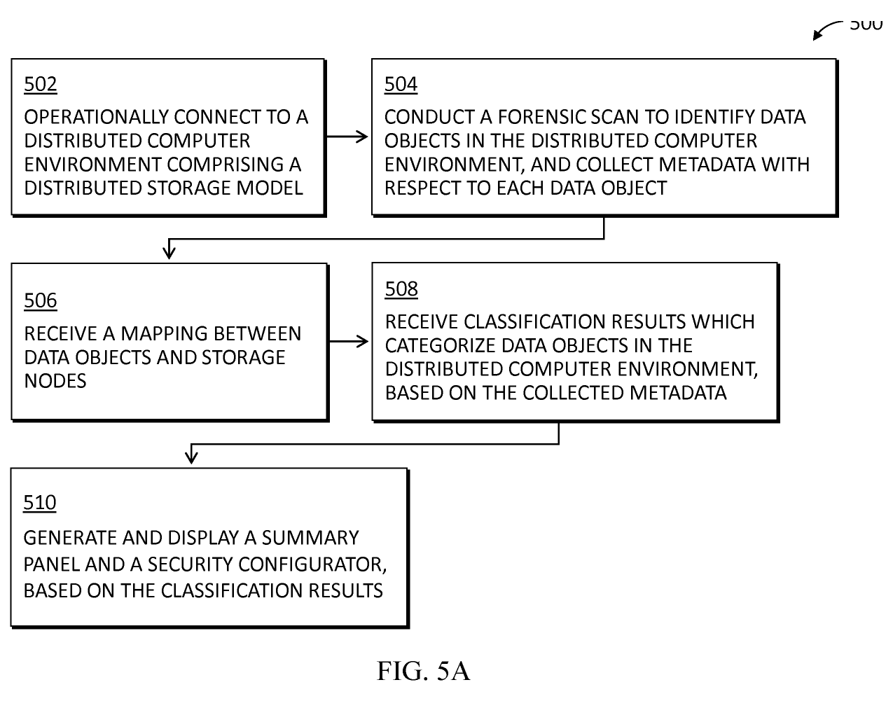

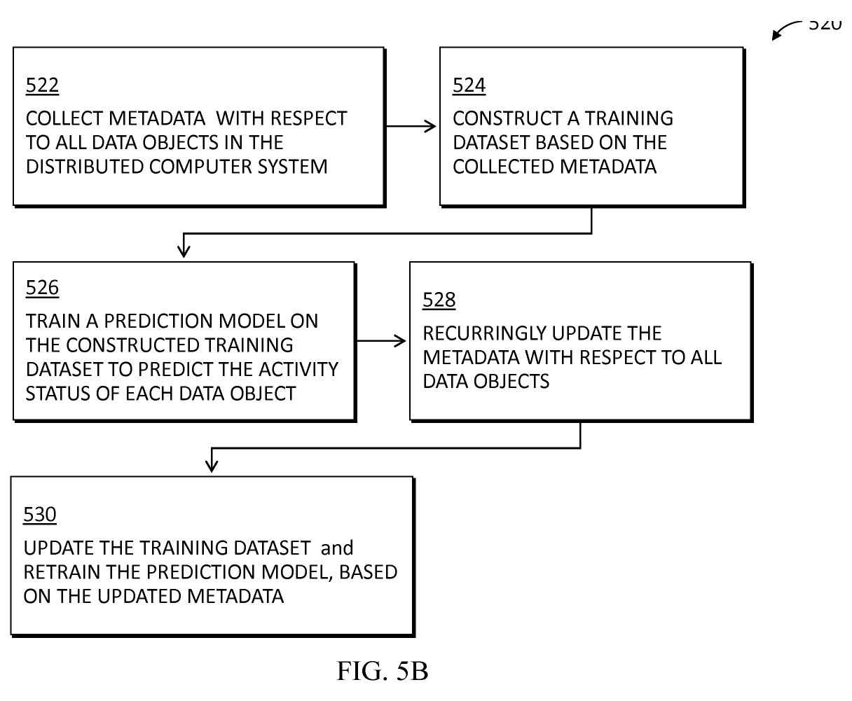

The instructions of exemplary system 400 will now be discussed with reference to the flowchart of FIG. 5A which illustrates the functional steps in a method 500 for dynamic centralized management and configuration of security policies and controls in a computer system. In some applications, method 500 is based, at least in part, on categorizing each of the data objects within a computer system, such as distributed computer system 100, according to its predicted activity status. In some embodiments, a predicted activity status indicates the likelihood that any such data object will be used and/or accessed within a predefined time window.

The various steps of method 500 will be described with continuous reference to exemplary system 400 shown in FIG. 4A and to the flowchart of FIG. 5A.

The various steps of method 500 may either be performed in the order they are presented or in a different order (or even in parallel), as long as the order allows for a necessary input to a certain step to be obtained from an output of an earlier step. In addition, the steps of method 500 may be performed automatically and/or recursively (e.g., by system 400 of FIG. 4A), unless specifically stated otherwise.

Method 500 begins in step 502, wherein system 400 executes data integration module 408 to operationally connect to a target computer system, typically a distributed or decentralized computer system having multiple interconnected systems and storage locations, over one or more private or public platforms. An example of such a system is exemplary distributed computer system 100 depicted in FIG. 1A, comprising exemplary distributed storage 120 depicted in FIG. 1B.

In some embodiments, computer system 100 may be any private, enterprise, governmental agency, healthcare facility, or similar computer system or environment.

In some embodiments, computer system 100 may comprise one or more of the following categories of nodes and platforms:

Traditional Network-Attached Storage and File Servers: These provide block-level or file-level storage over network file protocols, designed for shared file access. Examples include NetApp Filer, Windows File Server, and AWS EFS.

Object Storage: Immutable key-value stores accessed via REST/HTTPS. No hierarchy beyond prefixes. Examples include S3 Bucket, Azure Blob Storage, and Amazon Glacier.

Cloud Data Warehouse: Serverless, columnar data warehouse, such as Snowflake.

Relational Database: Open-source row/columnar relational databases, such as PostgreSQL.

Enterprise Content Management Document-centric storage includes document libraries, versioning, metadata, and personal cloud file sync and share. Examples include SharePoint, Office 365, and OneDrive.

Unified Storage Arrays: Such as Dell EMC.

Endpoint Detection and Response (EDR): Cloud-native EDR platform, such as CrowdStrike Falcon.

In one example, computer system 100 may comprise any one or more of the following elements:

A network 102 which interconnects the various nodes of distributed computer system 100and provides access to the stored data therein. Network 102 may comprise one or more interconnected private and public networks, including, but not limited to, a local area network (LAN), a virtual network, such as Microsoft Azure Virtual Network or similar, and/or the Internet.

An on-premise data center 104

One or more endpoints 106, such as workstations, laptops, and mobile devices.

Enterprise file storage 108

One or more public clouds 110

A private cloud 112

A blob storage 114

However, in other cases, computer system 100 may comprise fewer, additional, and/or other different components and elements.

In some embodiments, distributed computer system 100 may comprise a distributed storage 120, which may be organized as a plurality of storage nodes 122A-122N accessible to users of distributed computer system 100 according to a configurable data access plan. Each storage node 122 may be configured to store a plurality of data objects. In some cases, distributed computer system 100 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding scheme, such that the object data may be recreated from all or some of the generated portions, wherein the generated data object portions may be stored in one or more storage nodes 122A-122N.

In some embodiments, system 400 may execute integration module 408 to connect to data sources within computer system 100 using standard protocols, essentially functioning as a client. In some embodiments, system 400 may execute data integration module 408 to connect to sources within computer system 100 using a minimal set of privileges, typically with read-only access and/or with admin access level.

In some embodiments, system 400 may execute data integration module 408 to interface with one or more data sources within computer system 100, such as, but not limited to:

Windows/Linux operating systems.

Enterprise storage solutions from vendors such as Dell, NetApp, HP, Fujitsu, Pure and Vast.

Cloud storage platforms such as Google Drive, SharePoint (both online and on-premises), Box, Dropbox, and Amazon S3.

Common database platforms.

Common security tools.

With reference back to FIG. 4, in step 504, system 400 may execute data collection module 410 to receive the results of a forensic scan of distributed computer system 100, to create an inventory and mapping of all data objects in distributed storage 120. In some embodiments, such forensic scan may be performed by executing data integration module 408 and/or data collection module 410 to scan distributed computer system 100, to identify and create an inventory of all data objects, including, but not limited to:

Files.

Directories.

Databases.

Storage devices.

Installed programs or applications.

Users.

Groups.

Endpoints and end-devices.

Servers.

Network nodes.

Public and private cloud storage containers.

However, additional and/or different types or categories of objects may be included in the inventory created by system 400.

In some embodiments, system 400 may execute data collection module 410 to collect and store metadata with respect to the each data object identified in the forensic scan performed in step 504, e.g., in a dedicated storage resource of system 400 and/or using existing on-premises or cloud-based storage resources of distributed computer system 100. In some embodiments, the collected metadata may include, with respect to each data object, some or all of the metadata categories and elements detailed with reference to step 522 of method 520 described hereinbelow, which is incorporated herein by reference.

For example, system 400 may integrate with existing storage resources of computer system 100, such as NetApp storage platform, Windows File Servers, or other similar storage systems. In some embodiments, system 400 may execute data collection module 410 to receive the results of subsequent continuous or recurrent scans to update the logged or stored inventory of data objects with any additions and/or changes to data objects. Accordingly, system 400 may execute data collection module 410 to receive the results subsequent continuous or recurrent scans to update the logged or stored inventory of data objects with any (i) newly-created data objects, (ii) data objects that were deleted, and/or (iii) data objects that were modified or relocated within computer system 100. In some embodiments, such subsequent continuous or recurrent scans may be performed, for example, hourly, daily, weekly, bi-weekly, or according to any other shorter or longer desired interval.

In step 506, system 400 may execute data analysis module 412 to receive a mapping of all data objects within distributed computer system 100, which provides an indication with respect to the location of each data object within the various storage nodes 122A-122N of distributed storage 120. In some embodiments, such mapping may be generated by system 400 executing data analysis module 412 to generate and store a mapping of all data objects within distributed computer system 100, which indicates a mapping between each data object and one or more storage nodes 122A-122N in distributed storage 120.

In some embodiments, the generated mapping comprises, as applicable with respect to each data object, metadata with respect to one or more replicas of each data object, and/or metadata with respect to data objects with are divided into a number of portions according to an encoding scheme and stored over two or more different storage nodes 122A-122N. In some embodiments, the collected metadata may include, with respect to each data object, some or all of the metadata categories and elements detailed with reference to step 522 of method 520 described hereinbelow, which is incorporated herein by reference.

In step 508, system 400 may execute data analysis module 412 to receive classification results with respect to each of the data objects in distributed computer system 100, as identified in step 504 and mapped in step 506. In some embodiments, the classification results categorize data objects on the basis of geographic location, storage type (e.g., on-premise, private cloud, public cloud, etc.), data object type, applicable regulatory regime, applicable privacy controls, etc., and/or any combination of these categories.

In one example, system 400 may execute data analysis module 412 to receive prediction results which indicate a predicted activity status with respect to each of the data objects in distributed computer system 100, as identified in step 504 and mapped in step 506. In some embodiments, system 400 may execute data analysis module 412 to receive and associate and store with each data object in distributed computer system 100 as identified in step 504 and mapped in step 506, prediction results which indicate a predicted activity status with respect to the data object.

In some embodiments, predicted activity status with respect to each of the data objects in distributed computer system 100 is indicated by assigning each data object to one of a set of classes indicating the likelihood that such data object will be used and/or accessed within a predefined time window, such as the next hour, day 7 days, 14 days, 30 days, or any other desired or suitable period of time.

In some embodiments, the prediction results may be generated by executing machine learning module 414 to apply trained prediction model 416 to classify data objects within distributed computer system 100. In some embodiments, system 400 may execute machine learning module 414 to apply trained prediction model 416 to features extracted from metadata collected with respect to data objects in distributed computer system 100 (for example, one or more of the metadata types and categories as described with reference to step 522 in method 520 hereinbelow, which is incorporated herein by reference).

In some embodiments, the inferencing of trained prediction model 416 to classify data objects within distributed computer system 100 obtains predictions with respect to the predicted activity status of each data object.

In some embodiments, the predictions indicate, with respect to each data object in computer system 100, the likelihood that such data object will be used and/or accessed within a predefined time window. In some embodiments, the predefined time window may be e.g., the next hour, day, 7 days, 14 days, 30 days, or any other desired or suitable period of time. In some embodiments, the likelihood is expressed as a numerical value (e.g., on a scale from 1-5 or 0-100). In other cases, the likelihood is expressed as a discrete category, e.g., very high likelihood, high likelihood, moderate likelihood, low likelihood, very low likelihood.

In one embodiment, the predictions are based on a binary classification (i.e., 0/1, or yes/no) which indicates, with respect to each data object in computer system 100, that the data object is (i) ‘active,’ i.e., likely to be used and/or accessed within the predefined time window, or (ii) ‘inactive,’ i.e., unlikely to be used and/or accessed within the predefined time window. In some embodiments, each classification result is associated with a probability score. For example, the binary classification may indicate, with respect to each data object in computer system 100, that the data object is (i) ‘active,’ i.e., likely to be used and/or accessed within the predefined time window, when the probability score exceeds a specified threshold (e.g., 70%), or (ii) ‘inactive,’ i.e., unlikely to be used and/or accessed within the predefined time window, when the probability score is below the specified threshold.

In another embodiment, the predictions are based on a multi-class classification, which assigns one of a set of three or more predetermined class labels to each data object, selected form the following exemplary list of classes:

Class I: Data object is active and likely to be accessed on a read/write/modify basis within the predefined time window. This prediction may indicate globally, with respect to all authorized users of a data object, that the data object is active and is likely to be used and/or accessed within the predefined time window. Alternatively, this prediction may indicate separately, with respect to each user of a data object, whether the data object is active and likely to be used and/or accessed by such authorized user within the predefined time window. Data objects included in this category are currently open files, recently modified objects, frequently queried database records, and data in active workflows. Active data typically requires the fastest storage media and lowest functional barriers to access.

Class II: This class may include moderately-active data that are accessed occasionally, such as recently completed projects, periodic reports, or seasonal business data.

Class III: This class may include data objects that are expected to be accessed on a read-only basis, and are not expected to be modified or edited by users.

Class IV: Inactive or infrequently accessed data with low probability of access in the near term. This class may include historical records, archived emails, or completed audit files.

Class V: Extremely rarely accessed data retained primarily for long-term preservation, legal holds, or compliance requirements.

Class VI: Data object is inactive, and is likely to be accessed only for periodic system maintenance or similar purposes within the predefined time window.

In some embodiments, each such classification is associated with a probability score. In some cases, the set of classes may include intermediate categories, and may be tailored to the need of specific organizations of industries.

In step 510, system 400 may execute visualization generator 420 to generate and display (e.g., on a display monitor) a data object summary panel, such as exemplary data object summary panel shown in FIG. 3A, based on the classification results. In some embodiments, the data object summary panel provides a centralized graphical visualization of all data objects discovered, located and cataloged within the target computer system, such as distributed computer system 100.

In some embodiments, system 400 may execute visualization generator 420 to generate and display (e.g., on a display monitor) a data object summary panel, which presents a real-time dynamic centralized graphical visualization of all data objects discovered, located and categorized within computer system 100, according to their assigned category or class as determined in step 508.

In one example, the data object summary panel is configured based, at least in part, on the output results of trained prediction model 416 of the present technique, configured to output a classification which indicates a predicted activity status with respect to each of the data objects within distributed computer system 100. In some embodiments, the predicted activity status indicates the likelihood that such data object will be used and/or accessed by a user within a time window, such as within the next hour, day, 7 days, 14 days, 30 days, or any other desired or suitable period of time.

With reference back to FIG. 3A, an exemplary data object summary panel is shown, which provides a centralized graphical visualization of all data objects discovered, located and cataloged within a target computer system, such as distributed computer system 100.

In some embodiments, the data object summary panel presents a dynamic centralized graphical visualization of all data objects within the distributed storage schema of distributed computer system 100. For example, the data object summary panel presents a centralized graphical visualization of the predicted activity status of all data objects across all distributed storage nodes 122A-122N within distributed computer system 100.

In some embodiments, as can be seen in FIG. 3A, the data object summary panel may provide indication of the total number or proportion of data objects within each of the classification categories. Thus, the data object summary panel visually presents the output results of a trained prediction model of the present technique, configured to output a classification which indicates, with respect to each of the data objects in distributed computer system 100, the likelihood that such data object will be used and/or accessed by a user within a predefined time window, such as within the next hour, day, 7 days, 14 days, 30 days, or any other desired or suitable period of time.

In the exemplary data object summary panel shown in FIG. 3A, the prediction results present the allocation of all data objects within distributed computer system 100 among three categories or siloes:

Active Data Objects: Comprising approx. 2% of the total data objects in distributed storage 120 within distributed computer system 100hat are likely to be accessed on a read/write/modify basis by at least one of its users within the predefined time window.

Read-Only Data Objects: Comprising approx. 29.4% of the total data objects in distributed computer system 100 that are likely to be accessed only on a read-only basis by any of its users within the predefined time window.

Inactive data objects: Comprising approx. 68.5% of the total data objects in distributed storage 120within distributed computer system 100,that are unlikely to be used or accessed by any of its users within the predefined time window.

However, in other cases, the prediction results may include fewer, more, different, or alternative classes or categories.

The data object summary panel generated and displayed in step 510 may be used for centralized management and configuration of policies and controls applicable to data objects in distributed computer system 100. In some embodiments, the data object summary panel generated and displayed in step 510 may be used for centralized management and configuration of policies and controls applicable to data objects in distributed computer system 100, with respect to at least one class or category of data objects presented in the data object summary panel.

For example, the summary panel may provide a link to a security configurator, as shown in FIGS. 3B-3C, which permits centralized management and configuration of security controls and policies for each of the classification categories presented in the data object summary panel shown in FIG. 3A.

For example, in FIG. 3B, the security configurator permits centralized management and configuration of security controls and policies which will be applied dynamically centrally to all data objects within distributed computer system 100 classified as ‘active,’ i.e., are likely to be used and/or accessed on a read/write/modify basis within the predefined time window. Likewise, in FIG. 3C, the security configurator permits centralized management and configuration of security controls and policies which will be applied centrally to all data objects within distributed computer system 100 currently classified as ‘inactive,’ i.e., are unlikely to be used and/or accessed on a read/write/modify basis by at least one of its users within the predefined time window. The management and configuration of security and permissioning profiles may be applied via checkboxes or any other common form controls which allow users to select one or more options from a predefined list.

For example, the data object summary panel may be used to centrally apply a specified security configuration or customized security controls to one or more entire classes of data objects as a whole, regardless of the type or exact location of each data object within distributed computer system 100. Thus, applying a specified security policy, configuration, or control to a class of data objects presented in the data object summary panel, will cause the specified security policy, configuration, or control to be applied to each data object that is assigned to the relevant class, e.g., based on the classification results obtained in step 508.

In some embodiments, the data object summary panel may be used to centrally apply differential security and other configurations to one or more entire categories or classes of data objects, based on their predicted activity status, regardless of the exact location of each data object within distributed computer system 100. Thus, a first specified security policy, configuration, or control may be applied to a first class of data objects presented in the data object summary panel, while a second, different, specified security policy, configuration, or control may be applied to a second class of data objects presented in the data object summary panel. This will cause the specified security policy, configuration, or control to be applied to each data object that is assigned to the respective classes.

With reference back to FIGS. 3B-3C, the data object summary panel may provide one or more links to configurator or manager tools. For example, the data object summary panel may provide a link to a security configurator, which permits centralized management and configuration of security controls for each of the classification categories presented in the data object summary panel shown in FIG. 3A. Thus, in FIG. 3B, the security configurator permits centralized management and configuration of security controls which will be applied centrally to all data objects within distributed computer system 100, which are currently classified as ‘active,’ i.e., are likely to be used and/or accessed on a read/write/modify basis by at least one of its authorized users within the predefined time window. For example, the security configurator permits centralized management and configuration of security controls such as, but not limited to, read protection, write protection, access protection, multi-factor authentication, and the like.

Likewise, in FIG. 3C, the security configurator permits centralized management and configuration of security controls which will be applied centrally to all data objects within distributed computer system 100 currently classified as ‘inactive,’ i.e., are unlikely to be used and/or accessed on a read/write/modify basis by at least one of its authorized users within the predefined time window.

In some embodiments, the security policies and controls may be selected with respect to a class or category of data objects via checkboxes or any other common form controls which allow users to select one or more options from a predefined list.

For example, with reference back to FIGS. 3B-3C, the security configurator may be operated to select multiple checkboxes, each representing a particular security policy or control. In some embodiments, the list of security policies and controls which may be applied across classes of data objects may include the following categories of security policies and controls:

Data Classification and Labeling

Access Control Policies

Encryption Controls

Data Integrity and Validation

Audit and Monitoring

Data Lifecycle Management

Privacy and Compliance

Network and Transport Security

Data Loss Prevention (DLP)

Malware and Threat Protection

Replication and Distribution

Authentication and Authorization

Isolation and Segmentation

In some embodiments, some or all of the steps of method 500 may be repeated automatically by system 400 continuously, recurrently or periodically, e.g., based on an hourly, daily, weekly, bi-weekly, or according to any other predetermined shorter or longer schedule desired. Each such recurrence updates the classification results which indicate a predicted activity status with respect to each of the data objects in distributed computer system 100.

Accordingly, it is expected that the steps of operationally connecting to a target computer system (502), performing a data object scan and collecting metadata (504), updating the data objects mapping (506), receiving updated data object classification results (508), and generating an updated summary data object display (510), may be repeated continuously, recurringly or periodically, e.g., hourly, daily, weekly, bi-weekly, monthly, or according to any desired recurring schedule.

With every recurrence of method 500, it is expected that new data objects may be added to the overall inventory of the target distributed computer system; existing data objects may be removed from the overall inventory of the target distributed computer system; and/or existing data objects may be relocated to a different location within the target distributed computer system, thus necessitating an update to the mapping generated in step 506.

Likewise, it is expected that metadata with respect to existing data objects will change and evolve, sometimes triggering a revised classification of these data objects. Thus, existing data objects may be reclassified and migrate through the various categories or classes, thereby automatically and dynamically becoming subject to the security profile applicable to the respective classes or categories. Similarly, when an existing data object migrates out of a class or categories, it is no longer subject to the security profile applicable to that class.

The instructions of system 400 will now be discussed with reference to the flowchart of FIG. 5B which illustrates the functional steps in a method 520 for training and inferencing a prediction model configured to classify data objects in a distributed computer system according to their predicted activity status.

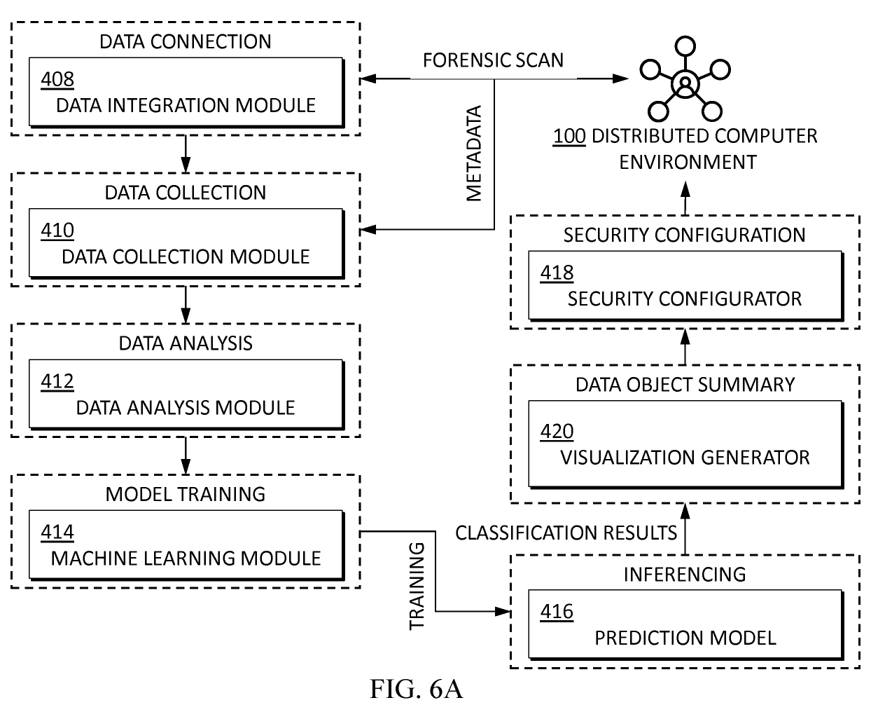

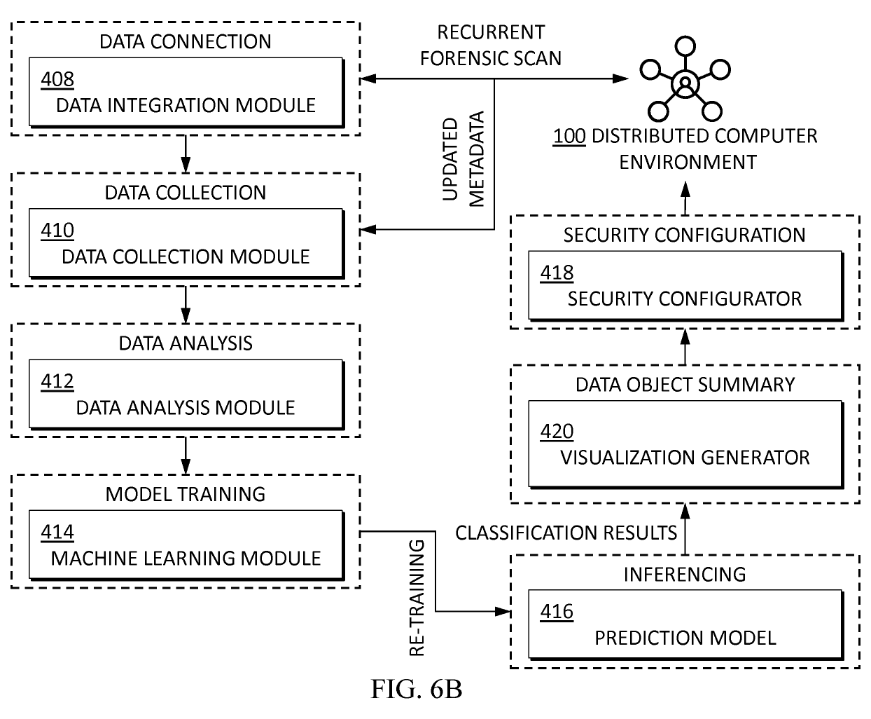

The various steps of method 520 will be described with continuous reference to exemplary system 400 shown in FIG. 3A, and to the block diagrams of FIGS. 6A-6B, which provide an overview of a pipeline for training, inferencing, and updating of a prediction model of the present technique.

The various steps of method 520 may either be performed in the order they are presented or in a different order (or even in parallel), as long as the order allows for a necessary input to a certain step to be obtained from an output of an earlier step. In addition, the steps of method 520 may be performed automatically (e.g., by system 400 of FIG. 3A), unless specifically stated otherwise.

Methods 520 begins in step 522, wherein system 400 may execute data integration module 408 to operationally connect to a computer system, typically a distributed or decentralized computer system having multiple interconnected systems and storage locations over one or more private or public platforms. An example of such a system is exemplary distributed computer system 100 depicted in FIG. 1A, comprising exemplary distributed storage 120 depicted in FIG. 1B.

In some embodiments, computer system 100 may be any private, enterprise, governmental agency, healthcare facility, or similar computer system or environment. In one example, computer system 100 may comprise any one or more of the following elements:

A network 102 which interconnects the various nodes of distributed computer system 100and provides access to the stored data therein. Network 102 may comprise one or more interconnected private and public networks, including, but not limited to, a local area network (LAN), a virtual network, such as Microsoft Azure Virtual Network or similar, and/or the Internet.

An on-premise data center 104

One or more endpoints 106, such as workstations, laptops, and mobile devices.

Enterprise file storage 108

One or more public clouds 110

A private cloud 112

A blob storage 114

However, in other cases, computer system 100 may comprise fewer, additional, and/or other different components and elements.

In some embodiments, distributed computer system 100 may comprise a distributed storage 120, which may be organized as a plurality of storage nodes 122A-122N accessible to users of distributed computer system 100 according to a configurable data access plan. Each storage node 122 may be configured to store a plurality of data objects. In some cases, distributed computer system 100 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding scheme, such that the object data may be recreated from all or some of the generated portions, wherein the generated data object portions may be stored in one or more storage nodes 122A-122N.

In some embodiments, system 400 may execute integration module 408 to connect to data sources within computer system 100 using standard protocols, essentially functioning as a client. In some embodiments, system 400 may execute data integration module 408 to connect to sources within computer system 100 using a minimal set of privileges, typically with read-only access and/or with admin access level.

In some embodiments, system 400 may execute data integration module 408 to interface with one or more data sources within computer system 100, such as, but not limited to:

Windows/Linux operating systems.

Enterprise storage solutions from vendors such as Dell, NetApp, HP, Fujitsu, Pure and Vast.

Cloud storage platforms such as Google Drive, SharePoint (both online and on-premises), Box, Dropbox, and Amazon S3.

Common database platforms.

Common security tools.

System 400 may then execute data collection module 410 to perform a forensic scan of computer system 100, to discover and create an inventory of all data objects in computer system 100. In some embodiments, system 400 may execute data collection module 410 to scan computer system 100, to identify and create an inventory of all data objects, including, but not limited to:

Files.

File directories.

User directories.

Databases.

Storage devices.

Software programs or applications.

Users.

Groups.

Endpoints and end-devices.

Servers.

Network nodes.

Public and private cloud storage containers.

However, additional and/or different types or categories of objects may be included in the inventory created by system 400.

In some embodiments, system 400 may execute data collection module 410 to log and/or store metadata with respect to the results of the inventory scan, e.g., in a dedicated storage resource of system 400 and/or using existing on-premises or cloud-based storage resources of computer system 100. For example, system 400 may integrate with existing storage resources of computer system 100, such as NetApp storage platform, Windows File Servers, or other similar storage systems.

In some embodiments, system 400 may execute data collection module 410 to perform continuous or recurrent scans to update the logged or stored inventory of data objects with any additions and/or changes to data objects. Accordingly, system 400 may execute data collection module 410 to perform subsequent continuous or recurrent scans to update the logged or stored inventory of data objects with any (i) newly-created data objects, (ii) data objects that were deleted, and/or (iii) data objects that were modified or relocated within computer system 100. In some embodiments, such subsequent continuous or recurrent scans may be performed, for example, hourly, daily, weekly, bi-weekly, or according to any other shorter or longer desired interval.

System 400 may then execute data collection module 410 to collect detailed metadata with respect to each of the data objects identified in computer system 100.

In some embodiments, system 400 may execute data collection module 410 to collect the following categories of metadata:

Temporal features: Including time since last access, time since last modification, age of the data item, and the like.

Frequency features: Number of accesses in the past defined period, average access frequency over a rolling window, burstiness score (e.g., variance in access intervals to detect sporadic vs. regular use).

Contextual features: Data type (e.g., image, document, code file—encoded as categorical variables), size of the data item.

User-specific patterns: Number of unique users who have accessed it, or user role/group.

System-wide signals: Overall system load or seasonal trends, like higher access during business hours.

Derived features: Recency-weighted frequency (e.g., using exponential decay to prioritize recent accesses).

Embeddings from metadata: File names or paths processed via NLP to infer content relevance.

In some embodiments, system 400 may execute data collection module 410 to collect the following metadata with respect to each data object as may be applicable, including, but not limited to:

Data object name (such as a file name). In some cases, the name may be encoded (e.g., using natural language processing methods, NLP), to convert any meaningful textual data object name into a representation which preserves the meaning of the name (while potentially also providing anonymization).

Data object tags (e.g., user-supplied tags).

Data object type (e.g., (e.g., format or application type).

Data object creation date.

Data object size.

Data object location within the network/path (e.g., a current, past or future location of the data object and network pathways to/from the data object).

Data object owner and/or author (e.g., the client or user that generates the data object), including, but not limited to:

Data object owner and/or author historical access and usage history with respect to other data objects, over a predefined period of time (e.g., most recent hour, day, 7 days, 14 days, 30 days, life of data object, etc.).

Data object owner and/or author historical access and usage history with respect to other data objects having similar names, over a predefined period of time (e.g., most recent hour, day, 7 days, 14 days, 30 days, life of data object, etc.).

Data object main contributors, identifying users who have made changes to the data object.

Data object content (e.g., an indication as to the existence of a particular search term).

Storage type (e.g., on-premise, private cloud, public cloud, etc.).

Geographic storage location.

Business unit (e.g., a group or department that generates, manages or is otherwise associated with the data object).

Data object historical access and usage:

Times of data object access instances (including, e.g., day of week, day of month, week of year, time of day, etc.), during a predefined period of time (e.g., most recent hour, day, 7 days, 14 days, 30 days, life of data object, etc.).

Count, frequency and recency of data object access during the predefined period of time.

Identity of accessing user(s).

Types of access (e.g., read/write/modify).

Statistics aggregating any historical access and usage data into statistics such as sum totals, counts, averages, etc.

Other data objects associated with the data objects:

Other data objects sharing the same or a similar name. In some cases, name similarity may be determined based on natural language processing (NLP) techniques. In other examples, data object names may be converted into a numerical representation (e.g., using textual embedding), which preserves the meaning of the name. Name similarly may be determined based on a distance between NLP or numerical representations, such as Euclidian distance or any other suitable measure.

Historical access and usage of other data objects sharing the same or a similar name.

Other data objects created within a specified time period of the data object (e.g., within one hour, day, 7 days, 14 days, month, or any other suitable time period before or after the creation of the data object).

Other data objects created within a specified time period of the data object (e.g., within one hour, day, 7 days, 14 days, month, or any other suitable time period before or after the creation of the data object) by the same owner and/or author.

Calendar appointments associated with the data object (for example, calendar appointments in which the data object is mentioned, linked to, or to which it is attached).

Email communications associated with the data object (for example, email communication in which the data object is mentioned, linked to, or to which it is attached).

Scheduled maintenance associated with the data object.

Data object and system metadata:

Boot sectors.

Partition layouts.

File location within a file folder directory structure.

User permissions.

Owners.

Groups.

Access control lists (ACLs).

Registry information.

The metadata may be collected with respect each data object over a rolling time window, e.g., most recent hour, day, 7 days, 14 days, 30 days, or any other suitable time window. In one example, the metadata may be collected for the life of each data object. In some cases, certain of the metadata may be aggregated into statistics, such as sum totals, counts, averages, etc.

In some embodiments, system 400 may execute data collection module 410 to store the collected metadata, e.g., in a dedicated storage resource of system 400 and/or using existing on-premises or cloud-based storage resources of computer system 100.

In some embodiments, after the initial metadata collection stage, system 400 may execute data collection module 410 to perform subsequent continuous or recurrent metadata collection scans, to update the logged or stored collected metadata with any additions and/or changes. For example, system 400 may execute data collection module 410 to perform subsequent continuous or recurrent metadata collection scans with respect to any newly-created data objects, and/or with respect to any data objects that were changed or modified since the most recent metadata collection scan.

In some embodiments, such subsequent periodic scans may be performed, for example, hourly, daily, weekly, bi-weekly, or according to any other shorter or longer desired interval.

System 400 may additionally execute data analysis module 412 to generate and store a mapping of all data objects within distributed computer system 100, which provides an indication with respect to the location of each data object within the various storage nodes 122A-122N of distributed storage 120. In some embodiments, the generated mapping comprises, as applicable with respect to each data object, metadata with respect to one or more replicas of each data object, and/or metadata with respect to data objects with are divided into a number of portions according to an encoding scheme and stored over two or more different storage nodes 122A-122N.

With reference back to FIG. 5B, in step 524, system 400 may execute data analysis module 412 to construct a training dataset from the metadata collected in step 408 with respect to the data objects in computer system 100.

In some embodiments, the constructed training dataset may comprise, for each data object, a set of features representing the data object and its respective data points, metadata and statistics as collected in step 522.

In some examples, a training dataset may comprise, for each data object, a set of features representing the data object and its respective data points, metadata and statistics, and data object over a defined period of time, as collected in step 522. In some embodiments, each set of features with respect to a data object may be labeled with a ground-truth label indicating whether the data object was subsequently used and/or accessed within a predefined time window, e.g., within the next hour, day, 7 days, 14 days, 30 days, or any other desired or suitable period of time. In some examples, a training dataset may comprise for each data object, a set of features representing the respective data points, metadata and statistics over a predefined period of time, as collected in step 522. In some embodiments, each such set of features may be labeled with a ground-truth label indicating whether the data object was subsequently used and/or accessed within a predefined time window, e.g., within the next hour, day, 7 days, 14 days, 30 days, or any other desired or suitable period of time.

With reference back to FIG. 5B, in step 526, system 400 may execute machine learning module 414 to train a machine learning model on the training dataset constructed in step 524, to obtain a trained prediction model.

In some embodiments, the machine learning model may comprise any one or more suitable machine learning algorithms, including, but not limited to, a combination of one or more classification algorithms, such as e.g., Random Forest, Gradient Boosting Classifier (e.g., XGBoost or LightGBM), Logistic Regression, Random Forest, or the like. In one example, the model can be trained to handle imbalanced classes (since inactive items are often more common) using techniques like class weighting or oversampling.

In some embodiments, a prediction model of the present technique may be trained to output a classification which indicates, with respect to each data object in computer system 100, the likelihood that such data object will be used and/or accessed within a predefined time window. In some embodiments, the predefined time window may be e.g., the next hour, day, 7 days, 14 days, 30 days, or any other desired or suitable period of time.

In one embodiment, the prediction model of the present technique is trained to output a binary classification (i.e., 0/1, or yes/no) which indicates, with respect to each data object in computer system 100, that the data object is (i) ‘active,’ i.e., likely to be used and/or accessed within the predefined time window, or (ii) ‘inactive,’ i.e., unlikely to be used and/or accessed within the predefined time window. In some embodiments, each classification result is associated with a probability score.

In some embodiments, the prediction model is trained to output a binary classification (i.e., 0/1, or yes/no) which indicates, with respect to each data object in computer system 100, that the data object is (i) ‘active,’ i.e., likely to be used and/or accessed within the predefined time window, when the probability score exceeds a specified threshold (e.g., 70%), or (ii) ‘inactive,’ i.e., unlikely to be used and/or accessed within the predefined time window, when the probability score is below the specified threshold.

In one variation of this embodiment, the prediction model may be trained to output a classification which indicates globally, with respect to all authorized users of a data object, that the data object is active and is likely to be used and/or accessed within the predefined time window. In another variation of this embodiment, the prediction model may be trained to output classification which indicates separately, with respect to each authorized user of a data object, whether the data object is active and likely to be used and/or accessed by such authorized user within the predefined time window.

In another embodiment, the predictions are based on a multi-class classification, which assigns one of a set of three or more predetermined class labels to each data object, selected form the following exemplary list of classes:

Class I: Data object is active and likely to be accessed on a read/write/modify basis within the predefined time window. This prediction may indicate globally, with respect to all authorized users of a data object, that the data object is active and is likely to be used and/or accessed within the predefined time window. Alternatively, this prediction may indicate separately, with respect to each user of a data object, whether the data object is active and likely to be used and/or accessed by such authorized user within the predefined time window. Data objects included in this category are currently open files, recently modified objects, frequently queried database records, and data in active workflows. Active data typically requires the fastest storage media and lowest functional barriers to access.

Class II: This class may include moderately-active data that are accessed occasionally, such as recently completed projects, periodic reports, or seasonal business data.

Class III: This class may include data objects that are expected to be accessed on a read-only basis, and are not expected to be modified or edited by users.

Class IV: Inactive or infrequently accessed data with low probability of access in the near term. This class may include historical records, archived emails, or completed audit files.

Class V: Extremely rarely accessed data retained primarily for long-term preservation, legal holds, or compliance requirements.

Class VI: Data object is inactive, and is likely to be accessed only for periodic system maintenance or similar purposes within the predefined time window.

In some cases, the set of classes may include intermediate categories, and may be tailored to the need of specific organizations of industries.

In some embodiments, each such classification is associated with a probability score. In some embodiments, the likelihood is expressed as a numerical value (e.g., on a scale from 1-5 or 0-100). In other cases, the likelihood is expressed as a discrete category, e.g., very high likelihood, high likelihood, moderate likelihood, low likelihood, very low likelihood.

In some embodiments, In a typical enterprise computer system or environment, the prediction model is expected to classify between 2-4% of the total data objects in computer system 100 as ‘active,’ i.e., data objects which are likely to be used and/or accessed on a read/write/modify basis within the predefined time window. In some embodiments, data objects classified as active, i.e., likely to be used and/or accessed on a read/write/modify basis within the predefined time window, may be stored in a dedicate storage cache, that is secure, scanned for malware, and virtually air-gapped from the rest of the data. In some embodiments, the active data objects are made available for access over the predefined time window using the standard login or permission protocols in use by the computer environment.

In some embodiments, the prediction model is expected to classify the balance of the data objects in computer system 100 (between 96-98% of the total) as ‘inactive,’ i.e., as data objects which are unlikely to be used and/or accessed on a read/write/modify basis within the predefined time window. In some embodiments, data objects classified as inactive and unlikely to be used and/or accessed on a read/write/modify basis within the predefined time window may be subject to enhanced security measures or protocols. For example, in some cases, a data object designated inactive may be subject to modified access protocols, which may require, for example, multi-factor authentication (MFA) to access the data object, or to have read and/or write privileges with respect to the data object. In some cases, a data object designated inactive may be designated as ‘read only,’ thereby eliminating write access to these data objects. Designating inactive data objects as ‘read only’ reduces the risk that these data objects will be encrypted in a ransomware attack. In other cases, a data object designated inactive may be subject to modified read and/or write permissions that are limited to only those users which have active authorization to use such data object, and have in fact accessed such data object within a recent specified period.

In the case the that prediction model is trained to output a binary classification (i.e., 0/1, or yes/no), the balance of the data objects (between 96-98% of the total) will be classified as ‘inactive,’ i.e., as data objects which are unlikely to be used and/or accessed on a read/write/modify basis within the predefined time window.

In the case that the prediction model is trained to output a multi-class classification as per the example given immediately above, the balance of the data objects in computer system 100, i.e., between 96-98% of the total, will be classified as one of, as the case may be: data object unlikely to be used or accessed within the predefined time window; data object likely to be accessed only on a read-only basis within the predefined time window; and/or data object likely to be accessed only for periodic system maintenance or similar purposes within the predefined time window.

With reference back to FIG. 5B, in step 528, system 400 may execute data collection module 410 to periodically or recurringly repeat step 522 of method 520 to (i) scan distributed computer system 100 to create an updated inventory of all data objects in distributed storage 120, (ii) generate an updated mapping of all data objects within distributed computer system 100, and (iii) collect updated detailed metadata with respect to the data objects in distributed computer system 100.

In step 530, system 400 may execute data analysis module 412 to periodically update the training dataset constructed in step 524, based on the updated metadata collected in step 428. System 400 may then execute machine learning module 414 to periodically or recurringly refine or re-train prediction model 416 on the updated training dataset, to obtain a re-trained prediction model.

In some embodiments, steps 528-530 of method 520 may be repeated continuously, recurrently or periodically by system 400, e.g., based on an hourly, daily, weekly, bi-weekly, or according to any other shorter or longer desired.

The present invention may be a system, a method, and/or a computer program product. The computer program product may include a computer readable storage medium (or media) having computer readable program instructions thereon for causing a processor to carry out aspects of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the "C" programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range – 10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method, comprising:
operationally connecting to a distributed computer system comprising a plurality of system nodes;
obtaining an inventory of all data objects in the distributed computer system;
collecting metadata regarding each of said data objects;
based on said metadata, applying a trained classification model to assign each of said data objects into one of a set of categories of data objects, based on a predicted likelihood that each data object will be accessed within a predefined time window;
generating, based on said assigning, a graphical data object summary and security configurator which allows for centrally applying differential security controls profiles to each of said categories of data objects; and
using said data object summary and security configurator to apply a specified said security controls profile to a respective one of said categories, wherein said security controls profile applies to all data objects assigned to said respective category.

2. The computer-implemented method of claim 1, wherein said set of categories includes at least the following categories: (i) active, indicating a respective said data object that is likely to be accessed within a predefined time window, and (ii) inactive, indicating a respective said data object that is unlikely to be accessed within said predefined time window.

3. The computer-implemented method of claim 1, wherein said prediction model is trained on a training dataset comprising a plurality of feature sets, each representing said metadata collected over a predefined time window with respect of each of said data objects, and wherein each of said feature sets is labeled with a label indicating user access instances with respect to said respective data object occurring subsequently to said defined time window.

4. The computer-implemented method of claim 3, wherein said metadata comprises, with respect to each of said data objects, historical access and usage data comprising one or more of the following: times of access instances; count, frequency and recency of access instances; identity of accessing users; and types of access instances.

5. The computer-implemented method of claim 1, wherein said connecting, obtaining, collecting, applying and generating is performed continuously or recurrently with respect to said computer system.

6. The computer-implemented method of claim 1, further comprising generating a mapping which identifies a location of each of said data objects within said system nodes of said distributed computer system, and wherein said applying is based on said mapping.

7. The computer-implemented method of claim 1, wherein said system nodes comprise one or more of the following categories of nodes: a network, an on-premise data center, one or more endpoints, an enterprise file storage, a public cloud, a private cloud, or a blob storage.

8. A system comprising:
at least one hardware processor; and
a non-transitory computer-readable storage medium having stored thereon program instructions, the program instructions executable by the at least one hardware processor to:
operationally connect to a distributed computer system comprising a plurality of system nodes,
obtain an inventory of all data objects in the distributed computer system,
collect metadata regarding each of said data objects,
based on said metadata, apply a trained classification model to assign each of said data objects into one of a set of categories of data objects, based on a predicted likelihood that each data object will be accessed within a predefined time window,
generate, based on said assigning, a graphical data object summary and security configurator which allows for centrally applying differential security controls profiles to each of said categories of data objects, and
use said data object summary and security configurator to apply a specified said security controls profile to a respective one of said categories, wherein said security controls profile applies to all data objects assigned to said respective category.

9. The system of claim 8, wherein said set of categories includes at least the following categories: (i) active, indicating a respective said data object that is likely to be accessed within a predefined time window, and (ii) inactive, indicating a respective said data object that is unlikely to be accessed within said predefined time window.

10. The system of claim 8, wherein said prediction model is trained on a training dataset comprising a plurality of feature sets, each representing said metadata collected over a predefined time window with respect of each of said data objects, and wherein each of said feature sets is labeled with a label indicating user access instances with respect to said respective data object occurring subsequently to said defined time window.

11. The system of claim 10, wherein said metadata comprises, with respect to each of said data objects, historical access and usage data comprising one or more of the following: times of access instances; count, frequency and recency of access instances; identity of accessing users; and types of access instances.

12. The system of claim 8, wherein said connecting, obtaining, collecting, applying and generating is performed continuously or recurrently with respect to said computer system.

13. The system of claim 8, wherein said program instructions are further executable to generate a mapping which identifies a location of each of said data objects within said system nodes of said distributed computer system, and wherein said applying is based on said mapping.

14. The system of claim 8, wherein said system nodes comprise one or more of the following categories of nodes: a network, an on-premise data center, one or more endpoints, an enterprise file storage, a public cloud, a private cloud, or a blob storage.

15. A computer program product comprising a non-transitory computer-readable storage medium having program instructions embodied therewith, the program instructions executable by at least one hardware processor to:
operationally connect to a distributed computer system comprising a plurality of system nodes;
obtain an inventory of all data objects in the distributed computer system;
collect metadata regarding each of said data objects;
based on said metadata, apply a trained classification model to assign each of said data objects into one of a set of categories of data objects, based on a predicted likelihood that each data object will be accessed within a predefined time window;
generate, based on said assigning, a graphical data object summary and security configurator which allows for centrally applying differential security controls profiles to each of said categories of data objects; and
use said data object summary and security configurator to apply a specified said security controls profile to a respective one of said categories, wherein said security controls profile applies to all data objects assigned to said respective category.

16. The computer program product of claim 15, wherein said set of categories includes at least the following categories: (i) active, indicating a respective said data object that is likely to be accessed within a predefined time window, and (ii) inactive, indicating a respective said data object that is unlikely to be accessed within said predefined time window.

17. The computer program product of claim 15, wherein said prediction model is trained on a training dataset comprising a plurality of feature sets, each representing said metadata collected over a predefined time window with respect of each of said data objects, and wherein each of said feature sets is labeled with a label indicating user access instances with respect to said respective data object occurring subsequently to said defined time window.

18. The computer program product of claim 17, wherein said metadata comprises, with respect to each of said data objects, historical access and usage data comprising one or more of the following: times of access instances; count, frequency and recency of access instances; identity of accessing users; and types of access instances.

19. The computer program product of claim 15, wherein said connecting, obtaining, collecting, applying and generating is performed continuously or recurrently with respect to said computer system.

20. The computer program product of claim 15, wherein said program instructions are further executable to generate a mapping which identifies a location of each of said data objects within said system nodes of said distributed computer system, and wherein said applying is based on said mapping.
